(19) United States
(12) Patent Application Publication
(10) Pub. No.: US 2003/0198934 A1
(43) Pub. Date: Oct. 23, 2003

(54) Branching script engine

(76) Inventors: Nachi Sendowski, El Cerrito, CA (US); Mark Dorner, San Francisco, CA (US); Roopa Balakrishnan, San Francisco, CA (US); Lovet Xavier Fernandes, San Leandro, CA (US)

Correspondence Address: GLENN PATENT GROUP, 3475 EDISON WAY, SUITE L, MENLO PARK, CA, 94025, US

(21) Appl. No.: 10/112,346

(22) Filed: Mar. 29, 2002

(51) Int. Cl. G09B 3/00

(52) U.S. Cl. 434/350; 434/362

(57) ABSTRACT

A system and method for providing a question-answer branching session over a stateless network. The invention provides a framework of reusable software objects implementing the creation and execution of any question-answer branching scripts. In the framework, scripts are used for the collection of structured information, surveys, interviews, evaluations, and expert diagnosis from application users. The components are data-driven by script definitions stored in a database. All persisted values, script progress path, and script results are kept in a predefined XML data structure. User interface and reported results are generated from the persisted data and sent to the client software for displaying via extensible style sheet transformation. Script questions are proceeded according to the values collected from previous answers. Script progress can be paused and resumed. Script answers can update token values and contains an additional text field. Script tokens can be used in questions and end of script processing. Questions with multiple answers cause recursive branching or stacking.

### BACKGROUND OF THE INVENTION

1. Technical Field

The invention relates generally to software technology for question-answer branching sessions over a stateless network. More particularly, the invention relates to a system and method that provide a framework of reusable software objects for implementing the creation and execution of any question-answer branching scripts.

2. Description of the Prior Art

A question-answer branching session is frequently used in various situations. For example, it is used in a phone menu tree system wherein one may access to his specific bank account by following the menu options. Various question-answer applications have been developed on the Internet. One of these is a Web site application designed for medical survey. In a survey session, a questioner's question that follows his prior question depends on a questionee's answer to the prior question. For instance, a first question is what age group does the questionee belong to. Depending on the questionee's answer to the first question, the questioner is to ask different questions about the questionee's health status. In such a Web site application, various processes are required to store the logic of decision making about what question should be presented to the questionee based on his or her answer to the previous question, to manage the path of the questions presented to the questionee, and to manage the path of the answers provided by the questionee.

The prior art solutions are narrowly customized for each specific type of application and cannot be generically applied to other types of application. In each of those applications, special databases and special user interfaces are required. In addition, a server has to keep a session alive to maintain the path of questions and answers for each client. During the session, the server knows which step the client is currently at and it allows going back and forth from one question to another. In the circumstance where multiple questions are presented, the server has to keep all the rest questions in the live session while it processes the answer to the first question. To keep the session alive, more memory will be used, and thus the server can only support a very limited number of concurrent users at a specific time. Therefore, these solutions can not scale up to meet the needs where thousands of concurrent users would be expected.

What is desired is to provide a generic system and method that can be applied to any type of question-answer branching applications and can support thousands of concurrent users when it is required.

### SUMMARY OF THE INVENTION

This invention provides a framework of reusable software objects implementing the creation and execution of any question-answer branching scripts. In this framework, scripts are used for the collection of structured information, surveys, interviews, evaluations, and expert diagnosis from application users. The components are data-driven by script definitions stored in a database. All persisted values, script progress path, and script results are kept in a predefined XML data structure. User interface and reported results are generated from the persisted data and sent to the client software for display via extensible style sheet transformation.

In the branching script engine described herein, script questions are proceeded according to the values collected from previous answers. Script progress can be paused and resumed. Script answers can update token values and contains an additional text field. Script tokens can be used in questions and end of script processing. Questions with multiple answers cause recursive branching or stacking. The branching script engine has various visual content elements, including questions, answers either multiple choice or text box, help text for questions and answers; and text generated. It also has various visual navigational elements, including a next question button, a previous question button, a pause button, and a cancel button.

### BRIEF DESCRIPTION OF THE DRAWINGS

FIG. 1 is a block diagram illustrating a communication network, comprising two user Web clients and a medical survey provider Web site, all coupled to the Internet;

FIG. 2 is a data flow diagram illustrating a process according to the invention, comprising various steps that collectively enable the functionality of the invention.

FIG. 3 shows a screen capture of the Web page that appears in a user's web browser when the user is in the middle of a survey where a single answer question is posted; and

FIG. 4 shows a screen capture of the Web page that appears in a user's web browser when the user is in the middle of a survey where a multiple-answer question is posted.

### DETAILED DESCRIPTION OF THE INVENTION

A. System Architecture

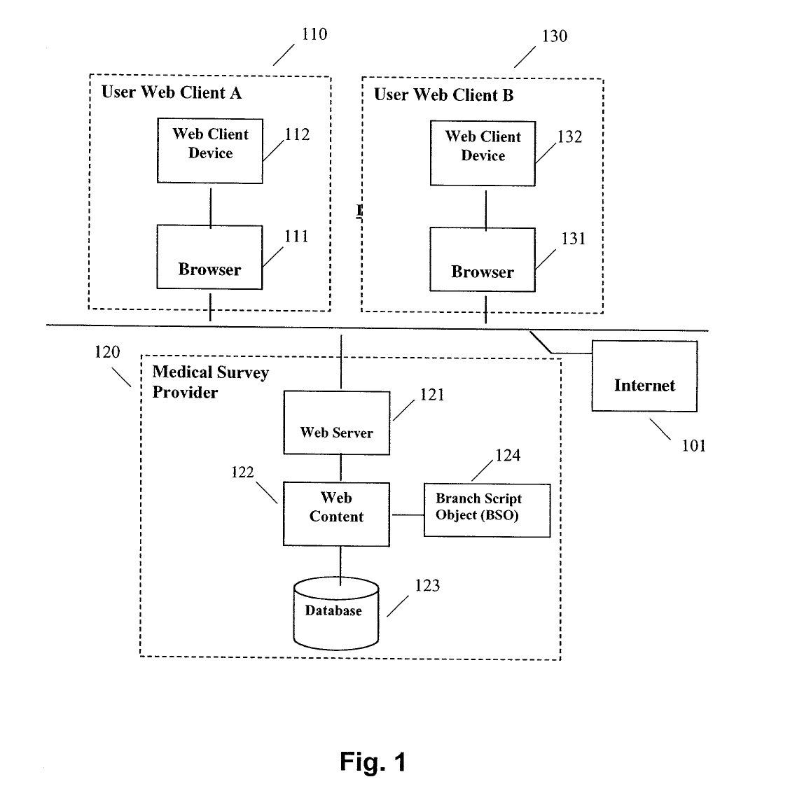

FIG. 1 is a block diagram that illustrates a system 100, comprising two user Web clients 110 and 130, and a medical survey provider Web site 120, all coupled to the Internet 101.

The Web site 120 includes a Web server 121, an associated Web content 122, and a database 123. The Web content 122 is coupled to a branch script object 124. The Web content entails all the services information that the Web site 120 provides to its clients such as doctors and patients.

The database 123 is used to store all script definitions such as questions, answers, sections and current script paths. It is also used to store the relationships among them, such as the branching among questions and answers.

The database 123 comprises the following tables:

The SCRIPT table: This table contains information about how a script path is constructed and what features the script supports. These features include whether a script path has sections or whether a script path can be paused. It also includes an extensible Style Language (XSL) template file that is used to transform the current script path (CSP) into Hyper Text Markup Language (HTML) so that it can be displayed on the user's screen. The detailed description of the SCRIPT table is shown in Table 1.

TABLE 1
Script

| Column Name | Data type | Description |
|---|---|---|
| Script | Int | The identity column that |
| | | is the primary key column |
| | | for the table. |
| TSLastModified | Timestamp | The Structured Query |
| | | Language (SQL) server |
| | | timestamp value for |
| | | concurrency, if necessary. |
| HandlingObject | Varchar(80) | The name of the object |
| | | (IscriptHandler) that |
| | | handles special custom |
| | | treatment for this script. |
| Name | Varchar(40) | The name of the script. |
| XSLFileName | Varchar(255) | The fully qualified path |
| | | name of the extensible |
| | | Style Language (XSL) file |
| | | that is used to do XML |
| | | transformations. |
| HasSections | Bit | A bit value to indicate |
| | | that the script has |
| | | sections and the section |
| | | table needs to be read. |
| CanPause | Bit | The flag to indicate that |
| | | the script can be paused. |
| ShowProgButton | Bit | The flag to indicate that |
| | | the script only displays a |
| | | button, clicking on which |
| | | will display the progress |
| | | as opposed to always |
| | | displaying the progress at |
| | | the bottom of the question. |
| EditSubmitURL | Varchar(255) | The page that handles |
| | | submissions of the script |
| | | when it is executed. |
| ImageFile | Varchar(255) | The name of an Image file, |
| | | with full path or path |
| | | relative to the Web |
| | | application, that is used |
| | | while the script is executed. |
| ProgressXSLFile | Varchar(255) | The name of the XSL file |
| | | that is used to display |
| | | the Progress. |
| StartQName | Varchar(255) | The first script question |
| | | name. |
| QuestionsPerPage | Int | The total number of |
| | | questions that are |
| | | displayed per page. |
| IntroText | Int | Foreign key to the introtext |
| | | table. This information is |
| | | being displayed before the |
| | | starting of the script. |

The QUESTION table: This table contains the information of questions such as question names, answer types, the texts to display to the user, as well as the belonging sections. It stores whether a question uses tokens and whether a question is a required question. It also stores the default next question to be displayed when the user skips a non-required question. If a question is the end of the branch, it can store the next question to be displayed after the question has been answered. The detailed description of the QUESTION table is shown in Table 2.

TABLE 2
QUESTION

| Column Name | Data type | Description |
|---|---|---|
| Question | Int | The identity column that |
| | | is the primary key |
| | | column for the table. |
| TSLastModified | Timestamp | The SQL server timestamp |
| | | value for concurrency, |
| | | if necessary. |
| Section_Questions | Int | The foreign key to the |
| | | Section_Questions table |
| | | that indicates the |
| | | section to which this |
| | | question belongs. |
| UsesTokens | Bit | The flag that indicates |
| | | that the question text |
| | | and the generated text |
| | | need to be parsed for |
| | | token names and replaced |
| | | with the token values. |
| QuestionText | Varchar(500) | The text that needs to |
| | | be displayed while |
| | | displaying the question. |
| DisplayText | Varchar(500) | The text that is used |
| | | when generating end |
| | | results from executing |
| | | the script - or while |
| | | displaying the progress. |
| AnswerType | Int | The type of answer to |
| | | expect for this question. |
| RequiredAnswer | Bit | The flag to indicate |
| | | that the question is a |
| | | required one. |
| HelpText | Varchar(500) | The text that can be used |
| | | for displaying any help |
| | | information on the question. |
| DefaultQuestiont | Int | The foreign key (self |
| | | reference) to the question |
| | | that is the default question, |
| | | if no answer is given |
| | | to the question. |
| QuestionName | Varchar(255) | The name of the question, |
| | | to be used internally |
| | | within scripts. |
| RootQuestion | Int | The foreign key (self |
| | | reference) to the question |
| | | that needs to be displayed |
| | | as the next question at the |
| | | end of branch. |
| DisplayProgress | Bit | The bit value to display |
| | | progress of the script. |

The ANSWER table: This table contains the information of answers such as labels and texts to be displayed. It also contains the belonging question and the next question to be displayed if the user selects the answer. For a text type answer, it allows the answer to be displayed as a text box. It also allows the answer to be collected into a named token. The detailed description of the ANSWER table is shown in Table 3.

TABLE 3
ANSWER

| Column Name | Data type | Description |
|---|---|---|
| Answer | Int | The identity column that |
| | | is the primary key |
| | | column for the table. |
| TSLastModified | Timestamp | The SQL server timestamp |
| | | value for concurrency, |
| | | if necessary. |
| Answerlabel | Varchar(100) | The name of the label |
| | | that gets displayed when |
| | | the answer is displayed |
| | | on the screen. |
| Question | Int | The foreign key to the |
| | | question that this |
| | | answer belongs to. |
| DisplayText | Varchar(500) | The text that should be |
| | | used, if the answer is |
| | | chosen. |
| DisplayPrefix | Varchar(500) | The text to be added as |
| | | a prefix to the display |
| | | text or the answer text. |
| DisplaySuffix | Varchar(500) | The text to be added as the |
| | | suffix to the display text |
| | | or the answer text. |
| TokenName | Varchar(500) | The name of the token |
| | | that the answer generates. |
| NextQuestion | Int | The foreign key to the next |
| | | question that is to be |
| | | displayed when the answer |
| | | is picked or answered. |
| DisplayAnswerAsIs | Bit | The flag to indicate that |
| | | the answer that is displayed |
| | | is to be the answer that |
| | | the person entered on the |
| | | HTML form. For option |
| | | buttons and check boxes, |
| | | this is the value of the |
| | | label. |
| ShowTextBox | Bit | For option buttons and |
| | | multiple check boxes, this |
| | | flag indicates that a text |
| | | box next to this item |
| | | needs to be displayed, |
| | | so that further details |
| | | can be given. |
| IsDynamic | Bit | If this bit is set, then |
| | | the answers are by |
| | | invoking corresponding |
| | | business rule server |
| NegativeText | Varchar(255) | This text will be |
| | | displayed in the final |
| | | report, if this answer |
| | | not been selected. |
| AnswerOrder | Int | The order by which |
| | | answer will be displayed |

The SECTION_QUESTIONS table: This table contains the information of sections such as the section names, the orders, the images to display to the user, and the belonging scripts. The detailed description of the SECTION_QUESTIONS table is shown in Table 4.

TABLE 4
SECTION_QUESTIONS

| Column Name | Data type | Description |
|---|---|---|
| Section_questions | Int | The identity column that |
| | | is the primary key |
| | | column for the table. |
| TSLastModified | Timestamp | The SQL server timestamp |
| | | value for concurrency, |
| | | if necessary. |
| Script | Int | The foreign key of the script |
| | | to which this section belongs. |
| Name | Varchar(40) | The name for the section. |
| SectionOrder | Int | The order of the section. |
| ImageFile | Varchar(255) | The name of the image file, |
| | | with full path or path relative |
| | | to the Web application, that |
| | | is to be used when displaying |
| | | a question that belongs |
| | | to this section. |

The database 123 also includes a SAVESCRIPT table which is used to save the current script path when a script path is paused or when the script path is completed.

The branch script object 124 is used to present a user with a script step, which includes a question, a set of answers, progress text and navigation controls. The object 124 is also used to process the script step when it is submitted. A submitted next step request is handled by accessing the script definition in said database 123 to determine the progress. The branch script object 124 maintains no state from one request to the next. The current script identity, progress path and position are persisted with the generated script step. Persisted values are used to restore state when the next step is requested. All persisted values and path is kept in a predefined XML structure. The detailed description of the XML structure is shown in Table 5.

TABLE 5
XML Structure

| | |
|---|---|
| 5. 1. ROOT | |
| Description | The root element. |
| Parent | None |
| XML Type | Element |
| DB Column (if any) | None |
| Exposed? | The entire XML Document Object |
| | Model (DOM) is exposed. |
| 5. 2. KEY | |
| Description | The key in the database for this |
| | particular script. |
| Parent | ROOT |
| XML Type | Attribute |
| DB Column (if any) | Script.Script |
| Exposed? | Write - Script.ScriptKey using the |
| | BuildNewScript function; |
| | Read - Script.ScriptKey. |
| 5. 3. SKEY | |
| Description | The key in the database for this |
| | saved script. It is used only when |
| | the saved script is to be resumed. |
| Parent | ROOT |
| XML Type | Attribute |
| DB Column (if any) | SaveScript.Script |
| Exposed? | Write - using the BuildSavedScript function; |
| | Read - Using the call to SetScriptAttribute. |
| 5. 4. QKEY | |
| Description | The key of the first question that |
| | is displayed when this script is executed. |
| Parent | ROOT |
| XML Type | Attribute |
| DB Column (if any) | Script.StartingQuestion |
| Exposed? | Read - Using the XML DOM; |
| | Write - Using the call to SetScriptAttribute. |
| 5. 5. QNAME | |
| Description | The name of the first question that |
| | is displayed when this script is executed. |
| Parent | ROOT |
| XML Type | Attribute |
| DB Column (if any) | Script.StartQName |
| Exposed? | Read - Using the XML DOM; |
| | Write - Although not recommended, the user |
| | can set this value using the XML DOM. |
| 5. 6. SSNAME | |
| Description | The name of the XSL file name |
| | (Style sheet name) to be used for |
| | displaying the contents of this script. |
| Parent | ROOT |
| XML Type | Attribute |
| DB Column (if any) | Script.XSLFileName |
| Exposed? | Read - Script.XSLFileName; |
| | Write - Script.XSLFileName. |
| | It will get overwritten (by the value |
| | persisted in the XML, or the DB value) |
| | if the object is built in any manner after |
| | setting this value. The value persisted in |
| | the XML will be the value from the DB, |
| | unless the change is made to the |
| | XML by the person, along with |
| | setting the property values. |
| 5. 7. HOBJ | |
| Description | The name of the server that deals |
| | with any special handling for the script. |
| Parent | ROOT |
| XML Type | Attribute |
| DB Column (if any) | Script.HandlingObiect |
| Exposed? | Read - Script.ScriptHandlerServer; |
| | Write - Script. |
| | ScriptHandlerServer. |
| | It will get overwritten (by the value persisted |
| | in the XML, or the DB value), if the object |
| | is built in any manner after setting this |
| | value. The value persisted in the |
| | XML will be the value from the DB, |
| | unless the change is made to the |
| | XML by the person, along with |
| | setting the property values. |
| 5. 8. NAME | |
| Description | The name of the object, if this |
| | needs to be used. |
| Parent | ROOT |
| XML Type | Attribute |
| DB Column (if any) | Script.Name |
| Exposed? | Read - Using the XML DOM; |
| | Write - Although not recommended, the user |
| | can set this value using the XML DOM. |
| 5. 9. IMG | |
| Description | The src value of the image that needs to be |
| | displayed while this script is executed. |
| Parent | ROOT |
| XML Type | Attribute |
| DB Column (if any) | Script.ImageFile |
| Exposed? | Read - Using the XML DOM; |
| | Write - Although not recommended, the user |
| | can set this value using the XML DOM. |
| 5. 10. URL | |
| Description | The URL to which the form should be |
| | submitted to. |
| Parent | ROOT |
| XML Type | Attribute |
| DB Column (if any) | Script.EditSubmitURL |
| Exposed? | Read - Script.EditSubmitURL; |
| | Write - Script.EditSubmitURL. |
| | It will get overwritten (by the value persisted |
| | in the XML, or the DB value), if the object |
| | is built in any manner after setting this |
| | value. The value persisted in the |
| | XML will be the value from the DB, |
| | unless the change is made to the |
| | XML by the person, along with |
| | setting the property values. |
| 5. 11. PAUSE | |
| Description | It contains 1 if the script can be |
| | paused at any time by the user. |
| Parent | ROOT |
| XML Type | Attribute |
| DB Column (if any) | Script.Canpause |
| Exposed? | Read - Using the XML DOM; |
| | Write - Although not recommended, the user |
| | can set this value using the XML DOM. |
| 5. 12. SPB | |
| Description | It contains 1 if the script is set |
| | to show progress button. |
| Parent | ROOT |
| XML Type | Attribute |
| DE Column (if any) | Script.ShowProgButton |
| Exposed? | Read - Using the XML DOM; |
| | Write - Although not recommended, |
| | the user can set this value using |
| | the XML DOM. |
| 5. 13. EOS | |
| Description | It contains 1 if the End of Script |
| | (EOS) has reached. This is |
| | available so that it is easy to |
| | determine if it is EOS or Beginning |
| | of Script (BOS) when using an XSL |
| | to display the contents of the XML file. |
| Parent | ROOT |
| XML Type | Attribute |
| DB Column (if any) | None |
| Exposed? | Read - Script.EOS; |
| | Write - Although not recommended, |
| | the user can set this value using |
| | the XML DOM. It could throw the |
| | display out of whack especially, if |
| | the default style sheet is used. |
| 5. 14. BOS | |
| Description | It contains 1 if BOS is reached by |
| | moving previous on the script. |
| | This is available so that it is |
| | easy to determine if it is EOS or |
| | BOS when using an XSL to display |
| | the contents of the XML file. |
| Parent | ROOT |
| XML Type | Attribute |
| DB Column (if any) | None |
| Exposed? | Read - Script.BOS; |
| | Write - Although not recommended, |
| | the user can set this value using |
| | the XML DOM. It could throw the |
| | display out of whack especially, if |
| | the default style sheet is used. |
| 5. 15. QPS | |
| Description | It contains the number of questions |
| | that are displayed per screen (page) |
| Parent | ROOT |
| XML Type | Attribute |
| DB Column (if any) | Questions Per Page |
| Exposed? | Read - QuestionsPerScreen |
| | Write - QuestionsPerScreen |
| 5. 15 ANS | |
| Description | The place holder for all the |
| | questions answered so far |
| Parent | ROOT |
| XML Type | Element |
| DB Column (if any) | No |
| Exposed | Read - Using the XML DOM |
| 5. 16 A | |
| Description | The place holder for the |
| | indiviadual answer. |
| Parent | ANS |
| XML Type | Element |
| DB Column (if any) | No |
| Exposed | Read - Using the XML DOM |
| 5. 17 KEY | |
| Description | The answer key |
| Parent | A |
| XML Type | attribute |
| DB Column (if any) | Answer.Answer |
| Exposed | Read - Using the XML DOM |
| 5. 18 QKEY | |
| Description | The question key, to which this |
| | answers belongs to |
| Parent | A |
| XML Type | attribute |
| DB Column (if any) | Answer.Question |
| Exposed | Read - Using the XML DOM |
| 5. 18 VALUE | |
| Description | The value user has chosen (entered) |
| Parent | A |
| XML Type | attribute |
| DB Column (if any) | |
| Exposed | Read - Using the XML DOM |
| 5. 19 LBL | |
| Description | The Label of the answer |
| Parent | A |
| XML Type | attribute |
| DB Column (if any) | Answer.AnswerLabel |
| Exposed | Read - Using the XML DOM |
| 5. 15. SECTION | |
| Description | The place holder for the section details |
| | for the different sections in this script. |
| | This node is created only if the |
| | HasSections attribute on the script has |
| | been set to 1 in the database. |
| Parent | ROOT |
| XML Type | Element |
| DB Column (if any) | None |
| Exposed? | Read - Using the XML DOM; |
| | Write - Although not recommended, |
| | the user can set this value using |
| | the XML DOM. |
| 5. 16. KEY | |
| Description | The key of the section. |
| Parent | SECTION |
| XML Type | Attribute |
| DB Column (if any) | Section_Questions.Section_Questions |
| Exposed? | Read - Using the XML DOM; |
| | Write - Although not recommended, |
| | the user can set this value using |
| | the XML DOM. |
| 5. 17. NAME | |
| Description | The name as it exists in the |
| | database for the section |
| Parent | SECTION |
| XML Type | Attribute |
| DB Column (if any) | Section_Questions.Name |
| Exposed? | Read - Using the XML DOM; |
| | Write - Although not recommended, |
| | the user can set this value using |
| | the XML DOM. |
| 5. 18. ORDER | |
| Description | The order as it exists in the |
| | database for this section |
| Parent | SECTION |
| XML Type | Attribute |
| DB Column (if any) | Section_Questions.SectionOrder |
| Exposed? | Read - Using the XML DOM; |
| | Write - Although not recommended, |
| | the user can set this value using |
| | the XML DOM. |
| 5. 19. IMG | |
| Description | The image value for this particular |
| | section, as it exists in the database. |
| Parent | SECTION |
| XML Type | Attribute |
| DB Column (if any) | Section_Questions.ImageFile |
| Exposed? | Read - Using the XML DOM; |
| | Write - Although not recommended, |
| | the user can set this value using |
| | the XML DOM. |
| 5. 20. TOKENS | |
| Description | The place holder for holding |
| | different tokens elements in the |
| | XML. The only reason this element |
| | exists, is so that the tokens can |
| | be accessed one after the other easily. |
| Parent | ROOT |
| XML Type | Element |
| DB Column (if any) | None |
| Exposed? | Read - Using the GetTokenNodeList |
| | function; |
| | Write - Calling the SetTokenValue |
| | function will create this element |
| | if one does not already exist. |
| 5. 21. TOKEN | |
| Description | The place holder for each token |
| | value under the tokens element |
| Parent | TOKENS |
| XML Type | Element |
| DB Column (if any) | None |
| Exposed? | Read - Using the GetTokenNodeList |
| | function; |
| | Write - Using the SetTokenValue function. |
| 5. 22. KEY | |
| Description | The key of the question that generated |
| | this token - useful when one gets |
| | rid of the tokens when moving previous. |
| Parent | TOKEN |
| XML Type | Attribute |
| DB Column (if any) | Copied in using the persisted XML |
| Exposed? | No |
| 5. 23. AKEY | |
| Description | The key of the answer to the |
| | question that generated this token. |
| | It is useful when one gets rid of |
| | the tokens when moving previous. |
| Parent | TOKEN |
| XML Type | Attribute |
| DB Column (if any) | Copied in using the persisted XML |
| Exposed? | No |
| 5. 24. NAME | |
| Description | The name of the token. This is the |
| | value that is set in the Answer |
| | node based on the TokenName |
| | attribute in the database. |
| Parent | TOKEN |
| XML Type | Attribute |
| DB Column (if any) | Copied in using the persisted XML |
| Exposed? | No |
| 5. 25. VALUE | |
| Description | The value that the user entered in |
| | the answer field when the question |
| | was displayed. |
| Parent | TOKEN |
| XML Type | Attribute |
| DB Column (if any) | None |
| Exposed? | Read - Using the function |
| | GetTokenValue or using the |
| | function GetTokenNodeList; |
| | Write - Using the function |
| | “SetTokenValue”. |
| 5. 26. STACK | |
| Description | The place holder for the answers |
| | that get placed on the stack. This |
| | collection is volatile, as values |
| | get placed into and thrown out of |
| | the stack as need arises. |
| Parent | ROOT |
| XML Type | Element |
| DB Column (if any) | None |
| Exposed? | Read - Using the XML DOM; |
| | Write - Although not recommended, |
| | the user can set this value using |
| | the XML DOM. |
| 5. 27. A | |
| Description | The place holder for each answer |
| | that gets placed into the stack. |
| Parent | STACK |
| XML Type | Element |
| DB Column (if any) | None |
| Exposed? | Read - Using the XML DOM; |
| | Write - Although not recommended, |
| | the user can set this value using |
| | the XML DOM. |
| 5. 28. QKEY | |
| Description | The key of the question. One of the |
| | user's responses is the answer for |
| | this question. |
| Parent | A |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 29. NKEY | |
| Description | The key of the next question that |
| | needs to be displayed for the answer. |
| Parent | A |
| XML Type | Attribute |
| DR Column (if any) | Copied in using the persisted XML |
| Exposed? | Read - Using the XML DOM; |
| | Write - Although not recommended, |
| | the user can set this value using |
| | the XML DOM. |
| 5. 30. NQNAME | |
| Description | The name of the next question that |
| | needs to be displayed for the answer. |
| Parent | A |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 31 PG | |
| Description | The place holder for all the questions |
| | which have been already answered |
| Parent | ROOT |
| XML | Element |
| DB Column (if any) | No |
| Exposed | Read - Using the XML DOM |
| 5. 31. Q | |
| Description | The place holder for each of the |
| | questions that the user has |
| | successfully answered so far. |
| Parent | PG |
| XML Type | Element |
| DB Column (if any) | None |
| Exposed? | Read - Using the XML DOM; |
| | Write - Although not recommended, |
| | the user can set this value using |
| | the XML DOM. |
| 5. 32. KEY | |
| Description | The key of the question that the |
| | user answered |
| Parent | Q |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 33. QNAME | |
| Description | The name of the question, as it |
| | exists in the database |
| Parent | Q |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 35. PRKEY | |
| Description | The key of the question that the |
| | user answered before answering this |
| | question to make it easy to move previous. |
| Parent | Q |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 36. FS | |
| Description | It contains 1 if this question was |
| | displayed as a result of an answer |
| | being popped from the stack (FS). |
| Parent | Q |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 37. FSQKEY | |
| Description | The key of the question that |
| | generated the entry for this |
| | particular question in the stack. |
| Parent | Q |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 41. STEP | |
| Description | The place holder for the current |
| | question that needs to be displayed. |
| Parent | ROOT |
| XML Type | Element |
| DB Column (if any) | None |
| Exposed? | Read - Using the XML DOM; |
| | Write - Although not recommended, |
| | the user can set this value using |
| | the XML DOM. |
| 5. 42. KEY | |
| Description | The key of the question that the |
| | user now needs to answer. |
| Parent | STEP |
| XML Type | Attribute |
| DB Column (if any) | Either |
| | Question.Question/Script.StartingQuestion/The |
| | next question key of the |
| | last answered answer |
| Exposed? | Read - Script.StepQuestion; |
| | Write - Although not recommended, |
| | the user can set this value using |
| | the XML DOM. |
| 5. 43. QNAME | |
| Description | The name of the question, as it |
| | exists in the database |
| Parent | STEP |
| XML Type | Attribute |
| DB Column (if any) | Copied in using the persisted XML |
| Exposed? | Read - Using the XML DOM; |
| | Write - Although not recommended, |
| | the user can set this value using |
| | the XML DOM. |
| 5. 44. PRKEY | |
| Description | The key of the question that the user |
| | answered prior to this question. |
| Parent | STEP |
| XML Type | Attribute |
| DB Column (if any) | Copied in using the persisted XML |
| Exposed? | Read - Script.PreviousQuestion; |
| | Write - Although not recommended, |
| | the user can set this value using |
| | the XML DOM. |
| 5. 45. SKEY | |
| Description | The key of the section to which |
| | this question belongs. |
| Parent | STEP |
| XML Type | Attribute |
| DB Column (if any) | Question.Step_Questions |
| Exposed? | Read - Using the XML DOM; |
| | Write - Although not recommended, |
| | the user can set this value using |
| | the XML DOM. |
| 5. 46. QTEXT | |
| Description | The question text to be displayed |
| | when the user is prompted with the |
| | question (plus any token |
| | translations, if the question is |
| | marked as using tokens) |
| Parent | STEP |
| XML Type | Attribute |
| DB Column (if any) | Question.QuestionText |
| Exposed? | Read - Using the XML DOM; |
| | Write - Although not recommended, |
| | the user can set this value using |
| | the XML DOM. |
| 5. 47. DISP | |
| Description | The text to be displayed when the |
| | progress is displayed to the user. |
| | The token translations, if any, are added if |
| | the question is marked as using tokens. |
| Parent | STEP |
| XML Type | Attribute |
| DB Column (if any) | Question.DisplayText |
| Exposed? | Read - Using the XML DOM; |
| | Write - Although not recommended, |
| | the user can set this value using |
| | the XML DOM. |
| 5. 48. TYPE | |
| Description | The question/answer type (the enum |
| | value for text box, combo box etc.). |
| Parent | STEP |
| XML Type | Attribute |
| DB Column (if any) | Question.AnswerType |
| Exposed? | Read - Using the XML DOM; |
| | Write - Although not recommended, |
| | the user can set this value using |
| | the XML DOM. |
| 5. 49. HELP | |
| Description | The help text for this question. |
| Parent | STEP |
| XML Type | Attribute |
| DB Column (if any) | Question.HelpText |
| Exposed? | Read - Using the XML DOM; |
| | Write - Although not recommended, |
| | the user can set this value using |
| | the XML DOM. |
| 5. 50. REQD | |
| Description | It contains 1 if this question is marked |
| | as “Required” in the database. |
| Parent | STEP |
| XML Type | Attribute |
| DB Column (if any) | Question.RequiredAnswer |
| Exposed? | Read - Using the XML DOM; |
| | Write - Although not recommended, |
| | the user can set this value using |
| | the XML DOM. |
| 5. 51. FS | |
| Description | It contains 1 if this question was |
| | displayed as a result of an answer |
| | being popped from the stack (FS). |
| Parent | STEP |
| XML Type | Attribute |
| DB Column (if any) | None |
| Exposed? | Read - Using the XML DOM; |
| | Write - Although not recommended, |
| | the user can set this value using |
| | the XML DOM. |
| 5. 52. FSQKEY | |
| Description | The key of the question that |
| | generated the entry for this |
| | particular question in the stack. |
| Parent | STEP |
| XML Type | Attribute |
| DB Column (if any) | None |
| Exposed? | Read - Using the XML DOM; |
| | Write - Although not recommended, |
| | the user can set this value using |
| | the XML DOM. |
| 5. 53. DQKEY | |
| Description | For non-required questions, this |
| | is the key of the question that |
| | needs to be the default next |
| | question when no answer is given |
| | to the current question. |
| Parent | STEP |
| XML Type | Attribute |
| DB Column (if any) | Question.DefaultQuestion |
| Exposed? | Read - Using the XML DOM; |
| | Write - Although not recommended, |
| | the user can set this value using |
| | the XML DOM. |
| 5. 54. NRQKEY | |
| Description | The “next root” at which the questioning |
| | continues once the end of branch is reached. |
| Parent | STEP |
| XML Type | Attribute |
| DB Column (if any) | Question.RootQuestion |
| Exposed? | Read - Using the XML DOM; |
| | Write - Although not recommended, |
| | the user can set this value using |
| | the XML DOM. |
| 5. 55. ERR | |
| Description | It is used for displaying errors |
| | when, for instance, the user does |
| | not provide the necessary answer |
| | for a required question. |
| Parent | STEP |
| XML Type | Attribute |
| DB Column (if any) | None |
| Exposed? | Read - Script.ErrorText; |
| | Write - Script.ErrorText. |
| 5. 56. A | |
| Description | The place holder for each of the |
| | responses received from the user |
| | for this question. |
| Parent | STEP |
| XML Type | Element |
| DB Column (if any) | None |
| Exposed? | Read - Using the XML DOM; |
| | Write - Although not recommended, |
| | the user can set this value using |
| | the XML DOM. |
| 5. 57. KEY | |
| Description | The key (in the database) of the |
| | answer to the current question. |
| Parent | A |
| XML Type | Attribute |
| DB Column (if any) | Answer.Answer |
| Exposed? | Read - Using the XML DOM; |
| | Write - Although not recommended, |
| | the user can set this value using |
| | the XML DOM. |
| 5. 58. LBL | |
| Description | The label, if any, that needs to be |
| | displayed for this answer. |
| Parent | A |
| XML Type | Attribute |
| DB Column (if any) | Answer.Label |
| Exposed? | Read - Using the XML DOM; |
| | Write - Although not recommended, |
| | the user can set this value using |
| | the XML DOM. |
| 5. 59. DISP | |
| Description | The display value for this answer, |
| | if any, that needs to be displayed |
| | for this answer. |
| Parent | A |
| XML Type | Attribute |
| DB Column (if any) | Answer.AnswerDisp |
| Exposed? | Read - Using the XML DOM; |
| | Write - Although not recommended, |
| | the user can set this value using |
| | the XML DOM. |
| 5. 60. PREFIX | |
| Description | The prefix that needs to be added |
| | to the user response. |
| Parent | A |
| XML Type | Attribute |
| DB Column (if any) | Answer.DisplayPrefix |
| Exposed? | Read - Using the XML DOM; |
| | Write - Although not recommended, |
| | the user can set this value using |
| | the XML DOM. |
| 5. 61. SUFFIX | |
| Description | The suffix that needs to be |
| | appended to the user response. |
| Parent | A |
| XML Type | Attribute |
| DB Column (if any) | Answer.DisplaySuffix |
| Exposed? | Read - Using the XML DOM; |
| | Write - Although not recommended, |
| | the user can set this value using |
| | the XML DOM. |
| 5. 62. TNAME | |
| Description | The name of the token that needs to |
| | be generated if the user enters a |
| | value for this answer or chooses |
| | this as one of his responses. |
| Parent | A |
| XML Type | Attribute |
| DB Column (if any) | Answer.TokenName |
| Exposed? | Read - Using the XML DOM; |
| | Write - Although not recommended, |
| | the user can set this value using |
| | the XML DOM. |
| 5. 63. NKEY | |
| Description | The key of the next question that |
| | needs to be displayed if the user |
| | enters a value for this answer or |
| | chooses this as one of his responses. |
| Parent | A |
| XML Type | Attribute |
| DB Column (if any) | Answer.NextQuestion |
| Exposed? | Read - Using the XML DOM; |
| | Write - Although not recommended, |
| | the user can set this value using |
| | the XML DOM. |
| 5. 64. ASIS | |
| Description | It contains 1 if the flag |
| | “DisplayAnswerAsIs” is set to true |
| | in the database. |
| Parent | A |
| XML Type | Attribute |
| DB Column (if any) | Answer.DisplayAnswerAsIs |
| Exposed? | Read - Using the XML DOM; |
| | Write - Although not recommended, |
| | the user can set this value using |
| | the XML DOM. |
| 5. 65. USETB | |
| Description | It contains 1 if the flag “Show |
| | text box” is set to true in the database. |
| Parent | A |
| XML Type | Attribute |
| DB Column (if any) | Answer.ShowTextBox |
| Exposed? | Read - Using the XML DOM; |
| | Write - Although not recommended, |
| | the user can set this value using |
| | the XML DOM. |

The branch script object 124 performs generic processing of any script such as determining the next step automatically and generating a proper HTML question form or question page. It controls the access to said database 123 to determine the progress of the script path, author questions, and populate progress text, etc. It also handles the process of any error conditions that might be encountered when accessing or attempting to display the script steps.

To accommodate for the stateless nature of these objects, no properties are kept from one session to the next. All required data would be persisted from either the database script definition or from the persisted XML path map. The branch script object 124 stores its domain specific properties when it is reinstated each time to complete a task. The detailed description of the properties supported by the branch script object 124 is shown in Table 6. The detailed description of the methods supported by the branch script object 124 is shown in Table 7.

TABLE 6
Properties Supported By The Branch Script Object

| | |
|---|---|
| 6. 1. DSN | |
| Description | Used by the object while querying the |
| | database to get the script properties, and |
| | the “current” questions and answers |
| | that need to be displayed. |
| Property Type | STRING [Read and Write] |
| Default | “Provider=SQLOLEDB;data |
| | source=HealinxDB1;user |
| | id=HealinxUser;password=change;initial |
| | catalog=Healinx;” |
| Persisted in the | No |
| XML? | |

6. 2. ScriptHandlerServer

| | |
|---|---|
| Description | The value of the server that is |
| | going to take care of the special handling, |
| | if any, for this particular script. |
| Property Type | STRING [Read and Write] |
| Default | None |
| Persisted in the | Yes. |
| XML? | The database value is the value that |
| | gets persisted. If this property is |
| | set to a different value at the run- |
| | time, the object will get used |
| | correctly, but will be persisted as |
| | found in the database for the script |
| | record. The run-time value is set |
| | only for that instance and will need |
| | to be reset every time when that |
| | object is used. If the run-time |
| | needs to be reset every time, it |
| | might make sense to look into the |
| | possibility of setting the value |
| | correctly in the database itself. |
| 6. 3. ScriptHandler | |
| Description | The OBJECT created using |
| | Objcontext.createinstache(ScriptHandlerServer) |
| Property Type | IScriptHandler [Read and Write] |
| Default | None |
| Persisted in the | No |
| XML? | |
| 6. 4. ScriptKey | |
| Description | The key of the script that needs to be executed. |
| Property Type | STRING [Read and Write] |
| Default | None |
| Persisted in the | Yes. |
| XML? | |

6. 5. ScriptXMLDOM

| | |
|---|---|
| Description | The reference to the XML DOM that |
| | holds the XML. |
| Property Type | DOMDOCUMENT [Read only] |
| Default | None |
| Persisted in the | It is the XML structure. |
| XML? | |
| 6. 6. XSLFileName | |
| Description | The name of the XSL file, with the |
| | full path or relative to the web |
| | application, that should be used |
| | while transforming the XML into HTML. |
| Property Type | STRING [Read and Write] |
| Default | App.Path + “\XSL\Default.xsl” |
| Persisted in the | Yes. |
| XML? | The database value is the value that |
| | gets persisted. If this property is |
| | set to a different value at the run- |
| | time, the XSL file will be used, but |
| | will not get persisted in the XML |
| | because it is set only for that instance. |
| | It needs to be set each time. If it is being |
| | reset every time, it probably makes more sense |
| | to set the value in the database anyway. |

6. 7. ProgressXSLFileName

| | |
|---|---|
| Description | The name of the XSL file, with the |
| | full path or relative to the Web |
| | application, that should be used |
| | while transforming the XML into HTML |
| | to display the progress. This would be useful |
| | if the show progress button is being |
| | displayed. Sometimes only the step needs |
| | to be displayed and sometimes only |
| | the progress needs to be displayed. |
| Property Type | STRING [Read and Write] |
| Default | App.Path + “\XSL\ProgDefault.xsl” |
| Persisted in the | Yes. |
| XML? | The database value is the value that |
| | gets persisted. If this property is |
| | set to a different value at the run- |
| | time, the XSL file will be used, but |
| | will not get persisted in the XML |
| | because it is set only for that |
| | instance. It needs to be set each |
| | time. If it is being reset every |
| | time, it probably makes more sense |
| | to set the value in the database anyway. |

6. 8. ScriptImageFile

| | |
|---|---|
| Description | The name of the Image file, with the |
| | full path or relative to the web |
| | application, that might be used to |
| | display a logo for the script. |
| Property Type | STRING [Read and Write] |
| Default | None |
| Persisted in the | Yes. |
| XML? | The database value is the value that |
| | gets persisted. If this property is |
| | set to a different value at the run- |
| | time, the image property will hold |
| | on to the value correctly, but the |
| | XML will still use the value from |
| | the database. This value may be re- |
| | set every time when needed. If it |
| | needs to be reset every time to the |
| | same value, it might make sense to |
| | look into the possibility of setting |
| | the value correctly in the database itself. |

6. 9. EditSubmitURL

| | |
|---|---|
| Description | The URL of the asp page that processes the |
| | submission of the script form. |
| Property Type | STRING [Read and Write] |
| Default | None |
| Persisted in the | Yes. |
| XML? | The database value is the value that |
| | gets persisted. If this property is |
| | set to a different value at the run- |
| | time, the image property holds on to |
| | the value correctly, but the XML |
| | will still use the value from the |
| | database. This value may be reset |
| | this every time when needed. If it |
| | needs to be reset every time to the |
| | same value, it might make sense to |
| | look into the possibility of setting |
| | the value correctly in the database itself. |
| 6. 10. StepQuestion | |
| Description | The key of the question that exists |
| | as the STEP node in the XML. |
| Property Type | STRING [Read] |
| Default | None |
| Persisted in the | Yes. |
| XML? | |

6. 11. PreviousQuestion

| | |
|---|---|
| Description | The key of the previous question that was |
| | displayed before the current step question. |
| Property Type | STRING [Read] |
| Default | None |
| Persisted in the | Yes. |
| XML? | |
| 6. 12. EOS | |
| Description | It returns true if EOS is reached. |
| Property Type | BOOLEAN [Read] |
| Default | None |
| Persisted in the | Yes. |
| XML? | |
| 6. 13. BOS | |
| Description | It returns true if BOS is reached. |
| Property Type | BOOLEAN [Read] |
| Default | None |
| Persisted in the | Yes. |
| XML? | |
| 6. 14. Error Text | |
| Description | If this property is set, it becomes the ERR |
| | attribute in the STEP node. This property gets |
| | set automatically by the script object when |
| | ReadStepRequest is called and no |
| | answer is given to a question marked |
| | as a “required” one. |
| Property Type | STRING [Read/Write] |
| Default | None |
| Persisted in the | Yes. |
| XML? | |

6. 15. Script Request or Login

| | |
|---|---|
| Description | The login key of the user who |
| | attempts to save the record or who |
| | attempts to resume a script. |
| Property Type | STRING [Read/Write] |
| Default | None |
| Persisted in the | No. |
| XML? | |

6. 16 QuestionsPerScreen

| | |
|---|---|
| Description | The number of questions to be |
| | displayed per screen |
| PropertyType | LONG[Read/Write] |
| Default | None |
| Persited in the XML | QPS |

TABLE 7
METHODS SUPPORTED BY THE BRANCH SCRIPT OBJECT

| 7. 1. BuildNewScript | |
|---|---|
| Parameter | [Optional] [String] - ScriptKey |
| description | |
| Return value | [Boolean] |
| | True - If successful |
| | False - if not |
| When is it used? | This is the function that needs to |
| | be called first for executing the script. |
| Description | If a script key is passed, this |
| | function copies the script key into |
| | its member variable. If it is not |
| | passed in, it assumes that the value |
| | is set using the property procedure. |
| | It then queries the database for the |
| | details of the script and creates the |
| | base XML structure that will be used. |
| Custom object | None. |
| intervention | |
| XML State after | If the script has sections, the |
| this point | <SCRIPT> node with all its attributes, |
| | and the <SECTION> node(s) with all its |
| | attributes, are needed. |
| 7. 2. Begin Script | |
| Parameter | |
| description | |
| Return value | [ScriptStepEnum] |
| | ScriptStepFirstReady = 1(if successful) |
| | ScriptStepCancel = 5 (if the Script |
| | handler chose to cancel the operation) |
| When is it used? | This is the function that needs to |
| | be called for setting the stage to |
| | display the starting question. |
| Description | This function sets the stage for |
| | displaying the first step. It uses |
| | the Startingquestion key for the |
| | script, goes to the database and |
| | then creates the “STEP” node using |
| | the values it retrieved. |
| | NOTE: Before this function is |
| | called, the script needs to be built |
| | using BuildNewscript. |
| Custom object | When this function is called, the |
| intervention | “BeforeBeginScript” function gets |
| | called first. |
| | After all the work is completed, the |
| | “AfterBeginScript” function in the |
| | Scriphandler gets called. |
| XML State after | If the script has sections and the |
| this point | <STEP> node with all possible |
| | answers, the <SCRIPT> node with all |
| | its attributes, and the <SECTION> |
| | node(s) with all its attributes, are needed. |
| 7. 3. ReadStepRequest | |
| Parameter | |
| description | |
| Return value | [Boolean] |
| | True - If everything is okay to |
| | proceed to the next step |
| | False - If the “Step” failed |
| | “Required answer” validation |
| When is it used? | This is the equivalent of the |
| | ReadSaveRequest in the DBRecord. It |
| | is used when it is needed to “re- |
| | build” the XML, to display the |
| | “Next” or the “Previous” step or to |
| | “Pause the script” or to display the |
| | progress so far. |
| Description | This function rebuilds the XML using |
| | the spath variable in the FORM |
| | collection of the Request object. |
| | It then checks to see, if the step |
| | questions are marked as “Required” |
| | and returns a False if no answer is |
| | given to one of the question. Then |
| | it checks to see, if the data given |
| | by the user is valid or not. If it |
| | is valid, then it calls ValidateAnswer |
| | method of business rule server. |
| Custom object | BusinessRules.ValidateAnswer |
| intervention | |
| XML State after | At this point, the XML would be re- |
| this point | instated to the same state as it was |
| | when the last ShowStep was done and |
| | the Step was displayed. The <ROOT> |
| | and <STEP> nodes are required. |
| | <SECTTON>, <TOKEN><STACK> and |
| | one or more <Q> nodes may be needed. |
| 7. 4. Move Next | |
| Parameter | |
| description | |
| Return value | [ScriptStepEnum] |
| | ScriptStepEOS = 4 - If the “Step” |
| | node could not be created because No |
| | next question was found. |
| | ScriptStepNextReady = 2 - If the “Step” |
| | node is created and the stage has been |
| | set for displaying the NEXT questions. |
| | ScriptStepCancel - 5 - if the Script |
| | handler chose to cancel the operation. |
| When is it used? | The corollary to BeginScript, when you |
| | want to set the stage to display the Next |
| | question(like in the ADO object model) |
| Description | This function uses the XML, converts |
| | the current step node to an |
| | equivalent “Q” (question) node. The |
| | “A” (answer) nodes under the |
| | question node gets created using the |
| | request object. The DisplayText, the |
| | question key, the FS (from stack |
| | indicator), the FSQKEY attribute |
| | value and the previous question key |
| | is persisted for the “Q” node. |
| | Before the creation of the “A” node, |
| | the object checks to make sure that it |
| | has a valid answer and if not uses |
| | the DQKEY (if any) in the XML structure |
| | to determine the next question. |
| | Factors need to be considered about |
| | the “A” node attribute: |
| | The key would be the key of the answer |
| | that the person picked or answered; |
| | The display value gets determined |
| | based on the way in which the answer |
| | is set up in the database. If the |
| | answer was set to “Display answer as |
| | is”, the value for this attribute is |
| | set to “Prefix” + the answer the |
| | person indicated + “Suffix”. If |
| | not, the attribute value is set to |
| | “Prefix” + “DisplayText” (in the |
| | database) “ “Suffix”. |
| | Token items get created, if the answer |
| | was supposed to be used as a token. Stack |
| | items get created if the person answered |
| | a multiple choice question with different |
| | branches. If the answer was a multiple |
| | choice answer, the possible next questions |
| | are initially pushed on to the stack and |
| | then the last one is popped from the stack. |
| | If no next answer could be found, an EOS |
| | is returned from this function. |
| | If the next answer is found, the |
| | “STEP” node gets created after |
| | querying the database and the |
| | function returns a “NEXTSTEPREADY” |
| | indicator. If the question key was |
| | set as a result of popping the stack |
| | the FS (From stack) and FSQKEY |
| | attributes get set on the STEP node. |
| | Before this function is called, the |
| | script needs to have been built or |
| | rebuilt using BuildNewscript or |
| | ReadStepRequest or BuildSavedScript. |
| Custom object | When this function is called, the |
| intervention | “BeforeNextScript” function gets |
| | called first. |
| | After all the work is completed, the |
| | “AfterNextScript” function in the |
| | Scriphandler gets called. |
| XML State after | At this point, the XML would contain |
| this point | the <SCRIPT> node. It could contain |
| | one or more <SECTION> nodes, <TOKEN> |
| | and <STACK> nodes and one or more |
| | <Q> nodes. It would contain a |
| | <STEP> node if EOS was not reached. |
| | If EOS was reached the <SCRIPT> node |
| | would contain an attribute to that effect. |
| 7. 5. Move Previous | |
| Parameter | |
| description | |
| Return value | [ScriptStepEnum] |
| | ScriptStepBOS = 0 - If the “Step” |
| | node could not be created because No |
| | previous question was found. |
| | ScriptStepPreviousReady = 3 - If the |
| | “Step” node is created and the stage |
| | has been set for displaying the |
| | PREVIOUS questions. |
| | ScriptStepCancel - 5 - if the Script |
| | handler chose to cancel the operation. |
| When is it used? | The corollary to BeginScript, when the stage |
| | is set to display the Previous question(like |
| | in the ADO object model). |
| Description | This function uses the XML, takes |
| | the previous question from the |
| | current “STEP” node. |
| | If the “Previous question” is not |
| | found, it gets rid of the “STEP” |
| | node, sets a BOS attribute on the <SCRIPT> |
| | node and returns a BOS indicator. |
| | If the “previous question” key was |
| | found, then: |
| | If the “FS” attribute was set on the |
| | “STEP” node, it reinstates the STACK |
| | for that question using the FSQKEY. |
| | It then gets rid of the STEP node. |
| | It then goes on to locate the “Q” |
| | node with the key equal to the previous |
| | key. It gets rid of all the TOKEN nodes |
| | and STACK nodes that were created as a |
| | result of answers to the “Q” node. It |
| | then queries the database using the previous |
| | question key, and creates the “STEP” |
| | node. It copies the previous |
| | question key value from the “Q” node |
| | into the STEP node. If the “Q” node |
| | contains the FS and FSQ attributes, |
| | it copies these into the STEP node. |
| | It gets rid of the “Q” node, and |
| | finally returns a ScriptStepPreviousReady |
| | to the caller. |
| | Before this function is called, the |
| | script needs to have been built or |
| | rebuilt using BuildNewscript or |
| | ReadStepRequest or BuildSavedScript. |
| Custom object | When this function is called, the |
| intervention | “BeforePreviousScript” function gets |
| | called first. |
| | After all the work is completed, the |
| | “AfterPreviousScript” function in |
| | the Scriphandler gets called. |
| XML State after | At this point, the XML would contain |
| this point | the <SCRIPT> node. It could contain |
| | one or more <SECTION> nodes, <TOKEN> |
| | and <STACK> nodes and zero or more |
| | <Q> nodes. It would contain a |
| | <STEP> node if BOS was not reached. |
| | If BOS was reached the <SCRIPT> node |
| | would contain an attribute to that effect. |
| 7. 6. Show StepHTML | |
| Parameter | |
| description | |
| Return value | [String] |
| When is it used? | Modeled after the EditFormHTML |
| | function in the database record. |
| | This function would be called in |
| | order to display the current question. |
| Description | This function uses the XML, and |
| | makes sure that there is are STEP |
| | nodes. If there is one, and |
| | m_ErrorText is not NULL, it adds the |
| | ERR attribute to the STEP node and tries to |
| | transform the XML using the XSLFileName |
| | property. It adds form tags to the |
| | transformed XML, calls the form “Script” |
| | plus the key of the script, sets the action |
| | to the EditSubmitURL value and hides the |
| | XML in an input item called spath, |
| | and finally returns the HTML. It sets the |
| | completion of the processing - so after |
| | this point, that instance of the |
| | object is pretty much destroyed. |
| | Before this function is called, the |
| | script needs to be built or rebuilt |
| | using BuildNewscript or |
| | ReadStepRequest or BuildSavedScript. |
| | The <STEP> node should be created |
| | using any of the move functions. |
| Custom object | The “ShowStepHTML” function is the |
| intervention | first thing that gets called. If |
| | this function returns |
| | ShowStepHTMLContinue (1), it |
| | continues with creating the HTML as |
| | described above. If the Function |
| | returns ShowStepHTMLProvided(2), it |
| | returns the HTML that the function |
| | returns in a byref variable, cleans |
| | up and sets complete. |
| XML State after | The object is destroyed and cannot |
| this point | be accessed. |
| 7. 7. Show ProgressHTML | |
| Parameter | |
| description | |
| Return value | [String] |
| When is it used? | Modeled after the EditFormHTML function |
| | in the dbrecord. This function is called in |
| | order to display the progress. |
| Description | This function uses the XML, and |
| | tries to transform it using the |
| | ProgressXSLFileName property. It |
| | adds form tags to the transformed |
| | XML, calls the form “Script” plus |
| | the key of the script, sets the action to the |
| | EditSubmitURL value and hides the XML |
| | in an input item called spath, and finally |
| | returns the HTML. It sets the completion of |
| | the processing - so after this |
| | point, that instance of the object |
| | is pretty much destroyed. |
| | Before this function is called, the |
| | script needs to be built or rebuilt |
| | using BuildNewscript or |
| | ReadStepRequest or BuildSavedScript. |
| | The <STEP> node should be created |
| | using any of the move functions. |
| Custom object | The “ShowStepHTML” function is the |
| intervention | first thing that gets called. If |
| | this function returns |
| | ShowStepHTMLContinue (1), it |
| | continues with creating the HTML as |
| | described above. If the Function |
| | returns ShowStepHTMLProvided(2), it |
| | returns the HTML that the function |
| | returns in a byref variable, cleans |
| | up and sets complete |
| XML State after | The object is destroyed and cannot |
| this point | be accessed. |
| 7. 8. End Script | |
| Parameter | [Optional] String - LoginKey |
| description | |
| Return value | [String] |
| When is it used? | When EOS is reached, this function, |
| | instead of the ShowStepHTML, might |
| | be called. |
| Description | If the Loginkey is passed in, it sets the |
| | ScriptRequestorLogin property to that |
| | value. If the ScriptRequestorLogin is still |
| | NULL, it raises an error. It then saves the |
| | XML in the SavedScript table and sets the |
| | completion of the processing. When saving |
| | the value to the table, it checks to see if |
| | there is already a SavedKey value existing |
| | in the XML. If it does, it uses that key to |
| | perform the update. If not, it conducts an |
| | insert into the table. Before this function |
| | is called, the script needs to be built |
| | or rebuilt using BuildNewscript or |
| | ReadStepRequest or BuildSavedScript. |
| Custom object | The “EndScript” function gets |
| intervention | called. |
| XML State after | The object is destroyed and cannot |
| this point | be accessed. |
| 7. 9. Pause Script | |
| Parameter | [Optional] String - LoginKey |
| description | |
| Return value | [Boolean] |
| | True - if paused successfully |
| | False - if not successful |
| When is it used? | The script is paused and may be |
| | resumed at a later time. |
| Description | If the Loginkey is passed in, it |
| | sets the ScriptRequestorLogin |
| | property to that value. If the |
| | ScriptRequestorLogin is still NULL, |
| | it raises an error. It then saves |
| | the XML in the SavedScript table, |
| | with the pause flag set to true and |
| | it sets the completion of the |
| | processing. When saving the value to |
| | the table, it checks to see if there |
| | is already a SavedKey value existing |
| | in the XML. If it does, it uses that |
| | key to perform the update. If not, |
| | it conducts an insert into the table. |
| | Before this function is called, the |
| | script needs to be built or rebuilt |
| | using BuildNewscript or |
| | ReadStepRequest or BuildSavedScript. |
| Custom object | The “EndScript” function gets |
| intervention | called. |
| XML State after | The object is destroyed and cannot |
| this point | be accessed. |
| 7. 10. BuildSavedScript | |
| Parameter | [String] - SavedScript |
| description | [Optional] String - LoginKey |
| Return value | [Boolean] |
| | True - If successful |
| | False - if not |
| When is it used? | This is the function that needs to be |
| | called first to resume a paused script. |
| Description | The function checks to make sure |
| | that the login key of the person |
| | attempting this request is the same |
| | as the person that saved the record |
| | in the database. It then goes on rebuild |
| | the XML structure by reading the database. |
| Custom object | None. |
| intervention | |
| XML State after | The XML in the state it was when the |
| this point | script is paused. |
| 7. 11. Resume Script | |
| Parameter | |
| description | |
| Return value | [ScriptStepEnum] |
| | ScriptStepResumeReady = 6 (if successful) |
| | ScriptStepCancel = 5 (if the Script |
| | handler chose to cancel the operation) |
| When is it used? | This is the function that needs to |
| | be called to set the stage to |
| | display the script from the point |
| | where the session was interrupted. |
| Description | The function ensures that the STEP |
| | node exists so the user can proceed |
| | with resuming the script. The main |
| | benefit of having this function is |
| | that the custom object can do a set |
| | of work if necessary before |
| | displaying the current question. |
| Custom object | Before this function is called, |
| intervention | “BeforeResumeScript” function gets called. |
| | After all the work is completed, the |
| | “AfterResumeScript” function in the |
| | Scriphandler gets called. |
| XML State after | The XML is in the state as it was |
| this point | when the script is paused. |

Script questions can use values collected from previous answers. Some answers can be marked and named as tokens. Tokens are stored with the persisted session path, keyed by name. Subsequent questions can use token values in the generated question text. Token text is substituted for marked tokens indicated by [TOKEN-NAME].

Questions allow for text answers, single choice answers and multi-choice answers. Each answer might require script branching. In the case of multi-choice answers, a stack of unbranched answers is maintained in the persisted session path.

Any special handling for specific scripts can be handled by creating custom script objects that comply with a declared interface. The interface IScriptHandler enforces implementation of key known methods which are then called at predefined processing points. The methods that need to be implemented by objects implementing the IscriptHandlerInterface are shown in Table 8.

TABLE 8
Functional Definition of the IscriptHandler Inteface

| 8. 1. BeforeBeginScript | |
|---|---|
| Parameter | [Script type] - Script |
| description | |
| Return value | [StepEnum] |
| | StepCancel = 1 Do not continue with |
| | the begin script function (somethings wrong) |
| | StepContinue = 2 Continue with default |
| | execution of the begin script function |
| | StepIgnore = 3 Just ignore the |
| | execution though there is nothing wrong |
| Description | This is the function the branch script |
| | object calls for handling special |
| | issues, if any, the first thing when |
| | the BeginScript function is executed. |
| 8. 2. AfterBeginScript | |
| Parameter | [Script type] - Script |
| description | |
| Return value | Can call to disable abort or |
| | enableabort to indicate success or |
| | failure. |
| Description | This is the function the branch |
| | script object calls for handling |
| | special issues, if any, just before |
| | the execution of the BeginScript |
| | function is completed. |
| 8. 3. Before NextStep | |
| Parameter | [Script type] - Script |
| description | |
| Return value | [StepEnum] |
| | StepCancel = 1 Do not continue with |
| | the Movenext function (somethings wrong) |
| | StepContinue = 2 Continue with |
| | default execution of the begin |
| | script function |
| | StepIgnore = 3 Just ignore the |
| | execution though there is nothing wrong |
| Description | This is the function the branch |
| | script object calls for handling |
| | special issues, if any, the first thing |
| | when the MoveNext function is executed. |
| 8. 4. AfterNextStep | |
| Parameter | [Script type] - Script |
| description | |
| Return value | Can call to disableabort or enableabort |
| | to indicate success or failure |
| Description | This is the function the branch |
| | script object calls for handling |
| | special issues, if any, just before |
| | execution of the MoveNext function |
| | is completed. |
| 8. 5. BeforePreviousStep | |
| Parameter | [Script type] - Script |
| description | |
| Return value | [StepEnum] |
| | StepCancel = 1 Do not continue with |
| | the Moveprevious function |
| | (somethings wrong) |
| | StepContinue = 2 Continue with |
| | default execution of the begin |
| | script function |
| | StepIgnore = 3 Just ignore the |
| | execution though there is nothing wrong |
| Description | This is the function the branch |
| | script object calls for handling |
| | special issues, if any, the first |
| | thing when the MovePrevious function |
| | is executed. |
| 8. 6. AfterPreviousStep | |
| Parameter | [Script type] - Script |
| description | |
| Return value | Can call to disableabort or enableabort |
| | to indicate success or failure. |
| Description | This is the function the branch |
| | script object calls for handling |
| | special issues, if any, just before |
| | the execution of the MovePrevious |
| | function is completed. |
| 8. 7. BeforeResumeScript | |
| Parameter | [Script type] - Script |
| description | |
| Return value | [StepEnum] |
| | StepCancel = 1 Do not continue with |
| | the ResumeScript function (somethings wrong) |
| | StepContinue = 2 Continue with |
| | default execution of the begin |
| | script function |
| | StepIgnore = 3 Just ignore the |
| | execution though there is nothing wrong |
| Description | This is the function the branch |
| | script object calls for handling |
| | special issues, if any, the first |
| | thing when the ResumeScript function |
| | is executed. |
| 8. 8. AfterResumeScript | |
| Parameter | [Script type] - Script |
| description | |
| Return value | Can call to disableabort or |
| | enableabort to indicate success or |
| | failure |
| Description | This is the function the branch |
| | script object calls for handling |
| | special issues, if any, just before |
| | the execution of the ResumeScript |
| | function is completed. |
| 8. 9. PauseScript | |
| Parameter | [Script type] - Script |
| description | |
| Return value | [StepEnum] |
| | StepCancel = 1 Do not continue with |
| | the PauseScript function (somethings wrong) |
| | StepContinue = 2 Continue with |
| | default execution of the begin |
| | script function |
| | StepIgnore 3 Just ignore the execution |
| | though there is nothing wrong |
| Description | This is the function the branch |
| | script object calls for handling |
| | special issues, if any, the first |
| | thing when the PauseScript function |
| | is executed. |
| 8. 10. EndScript | |
| Parameter | [Script type] - Script |
| description | |
| Return value | [StepEnum] |
| | StepCancel = 1 Do not continue with |
| | the EndScript function (somethings wrong) |
| | StepContinue = 2 Continue with |
| | default execution of the begin |
| | script function |
| | StepIgnore 3 Just ignore the execution |
| | though there is nothing wrong |
| Description | This is the function the branch |
| | script object calls for handling |
| | special issues, if any, the first thing |
| | when the EndScript function is executed. |
| 8. 11. ShowStepHTML | |
| Parameter | [Script type] - Script |
| description | [String ByRef] - Shtml |
| Return value | [ShowStepHTMLEnum] |
| | ShowStepHTMLContinue = 1 Continue |
| | with the ShowStepHTML function in |
| | the script object |
| | ShowStepHTMLProvided = 2 Do not |
| | bother with the default handling, |
| | the HTML has been provided in the |
| | byref variable. |
| Description | This is the function the branch |
| | script object calls for handling |
| | special issues, if any, the first |
| | thing when ShowStepHTML function is |
| | executed. |
| 8. 12. ShowProgressHTML | |
| Parameter | [Script type] - Script |
| description | [String ByRef] - Shtml |
| Return value | [ShowStepHTMLEnum] |
| | ShowStepHTMLContinue = 1 Continue |
| | with the ShowProgressHTML function |
| | in the script object. |
| | ShowStepHTMLProvided = 2 Do not |
| | bother with the default handling, |
| | the HTML has been provided in the |
| | byref variable. |
| Description | This is the function the branch |
| | script object calls for handling |
| | special issues, if any, the first |
| | thing when the ShowProgressHTML |
| | function is executed. |
| 8. 13 BeforeNextQuestionOnPage | |
| Parameter | [Long ] - NodeNumber |
| description | [IXMLDOMElement ByRef] - CurElement |
| | [Script] - Script |
| Return value | NextOnPageEnum - Enum |
| | NextQuestionContinue - Continue |
| | adding the question |
| | NextQuestionProvided - Don't add the |
| | current question |
| | NextQuestionAbort - Quit the adding |
| | nodes procedure |
| Description | This is the function ScriptingEngine |
| | calls for handling any special |
| | issues(if any), before adding the |
| | question. |
| 8. 14 AfterNextQuestionOnPage | |
| Parameter | [Long ] - NodeNumber |
| description | [IXMLDOMElement ByRef] - CurElement |
| | [Script] - Script |
| Return Value | |
| Description | This is the function scriptingengine |
| | calls to handle any special |
| | issues(if any), after adding the |
| | question to the current page |
| 8. 15 ExpandAnswerXMLDOM | |
| Parameter | [adodb.RecordSet] - adoRs |
| description | |
| Return Value | |
| Description | This is the procedure Scripting |
| | engine calls to add the answer nodes |
| | to question node. [this is possible |
| | only when when isdynamic is set on |
| | the answer and SQL String is added |
| | to the Label of the question] |
| 8. 16 ValidateAnswer | |
| Parameter | [Script ] - Script |
| description | [IXMLDOMElement] - StepNode |
| Return Value | Boolean |
| Description | This is the function is getting |
| | called by the scriptiong engine when |
| | the read step is called, so we can |
| | validate every one of the steps |
| 8. 17 ValidatePage | |
| Parameter | [Script ] - Script |
| description | [String ByRef] - ScriptError |
| Return Value | Boolean |
| Description | This is function getting called by |
| | the scripting engine, when the read |
| | step request is called, right after |
| | all the steps have passed validation |

Generic handling by the HBranchScripting.Script object is then augmented or replaced completely by the custom script objects. These objects are enabled to reside in Microsoft Transaction Server, which allows for significant scaling and transactional integrity.

The HBranchScripting.Script component has the capability to automatically generate an HTML question page or question form to solicit and submit back user input; automatically generate the HTML to display script progress; automatically generate proper navigation controls; persist the XML script progress and path; process form submission and determine next step; invoke custom handling objects; save script results (including both the completed and the paused scripts); and generate, or call to generate, reports from saved script results.

The user Web client 110 includes a browser 111 installed on a user Web client device 112. The user here may be a doctor who conducts a survey through said Web site 120 or a patient 130 who supplies answers to the questions posted by said Web site 120. For illustration purpose, only two user Web clients are shown in FIG. 1. In actuality, the number of user Web clients varies, depending on practical considerations such as server capacity and speed, memory capacity, and the Internet channel bandwidth.

The user Web client device 112 and 132 are preferably personal computers, but alternatively they could be any Web-enabled device capable of sending and receiving information via the Internet 101, such as a personal digital assistant or the like.

B. The Operation Process

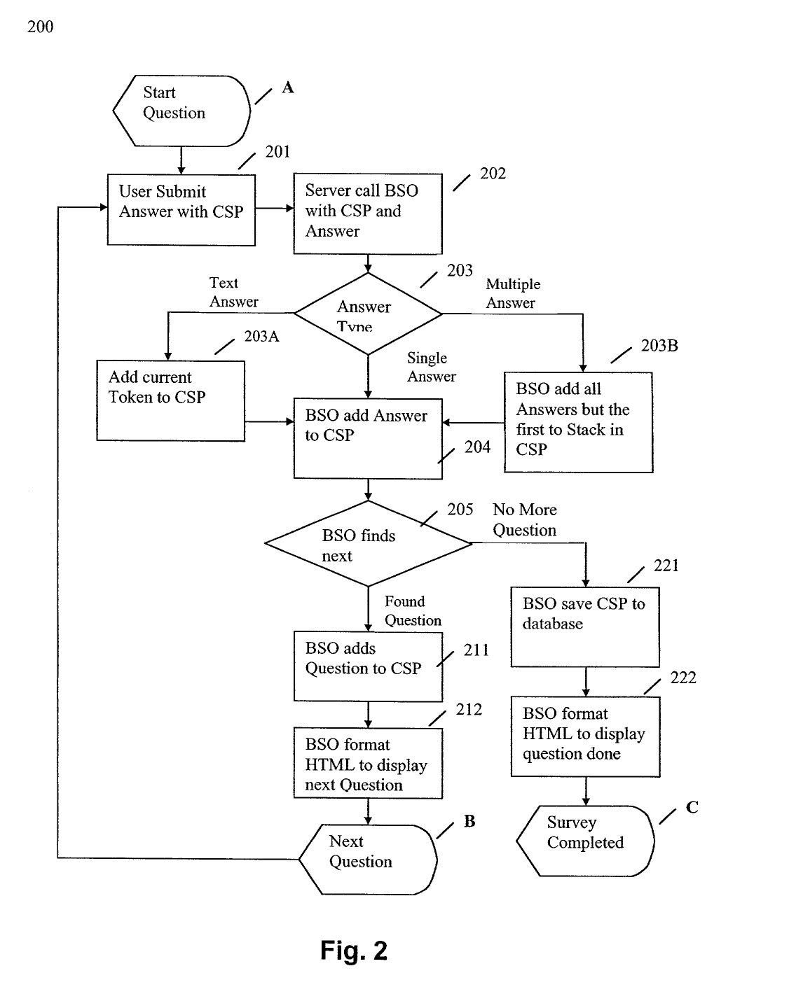

FIG. 2 is a data flow diagram illustrating a process 200 for providing a question-answer branching session in a stateless network according to the invention.

The process 200 comprises the following steps that collectively enable the functionality of the invention:

Step 201: A user, who has accessed to the medical survey provider Web site 120 via a browser 111 to start a survey (Page A in FIG. 2), responds to the first survey question and submits his answer. If this question is not the very first one, the current script path (CSP) is submitted at the same time.

Step 202: The medical survey provider Web server 121 receives the user answer and encoded the current script path and calls the branch script object 124.

Step 203: If this is the start of the script path, the branch script object 124 queries the database 123 for the details of the script and creates the base XML structure and creates the “STEP” node using the start question for current script. Otherwise it decodes the encoded current script path and rebuilds the XML structure. It then checks to see when the user answers the question.

The answer type may be “single answer”, “text answer” or “multiple answer”. If it is a single answer, the process continues on Step 204. If it is a text answer, the process continues on Step 203A. If it is a multiple answer, the process continues on Step 203B.

Step 203A: The branch script object 124 adds the text answer as a named token to the current script path if the text answer is configured to be a token so that the token can be used in subsequent questions and answers. For example, if current question is “What's your name?” and the user's response is “Dave”. The branch script object 124 hence adds the answer text “Dave” as the value for the token “PATIENT NAME”. Then in the next question, the branch script object 124 may use this token to present a question like “Hello, Dave . . . ”

Step 203B: The branch script object 124 uses the first answer to find next question and keeps the rest answers to its internal stack. By doing this, the script path for the remaining answers may be branched when the current script path for the current answer is completed.

Step 204: The branch script object 124 adds the answer to the current script path along with current question.

Step 205: The branch script object 124 queries the database 123 for next question based on the current question and the answer to the current question on the script path. Depends on whether there are further questions, the process continues on Steps 211-212 or Steps 221-222.

Step 211: When a next question is found, the branch script object 124 adds the question to the current script path and thereby the question becomes the current question.

Step 212: The branch script object 124 formats the current question to HTML page and sends it to the user's browser along with the current script path (Page B in FIG. 2).

The branch script object 124 also encodes the current script path and includes it into the responding HTML so that the server does not need to store them in user's session.

The current script path (CSP) contains all questions presented to the user and his answers to the questions as well as the current question that the user is to answer. It also contains remaining answers to be branched as well as tokens that have been collected so far.

The current script path can be stored in XML. By defining XSL templates, XML can be easily transformed to HTML. Because the text answers to previous questions have been added to the current script path as tokens, these tokens can be used in current questions or selection choices or any places when formatting the returning HTML page to show the user the next step.

The generated HTML page may contain questions, answers, help text for questions and answers, as well as generated text. It may also contain navigational elements such as next question button, previous question button, pause button and cancel button.

Steps 201-212 may be repeated until the last question has been answered. Then, the process continues on Steps 221-222.

Step 221: When no further question is found, the branch script object 124 saves the current script path to the database 123. If the same CSP has been saved to the database 123 because of a “Pause” request, the original record is to be updated. Otherwise the CSP is inserted into the table “SAVESCRIPT”. The current script path contains all questions the user received and all answers the user gave during the survey. These questions and answers can be retrieved for further processing.

Step 222: The branch script object 124 formats an HTML page that notifies the user the completion of the survey as shown in Web page C in FIG. 2.

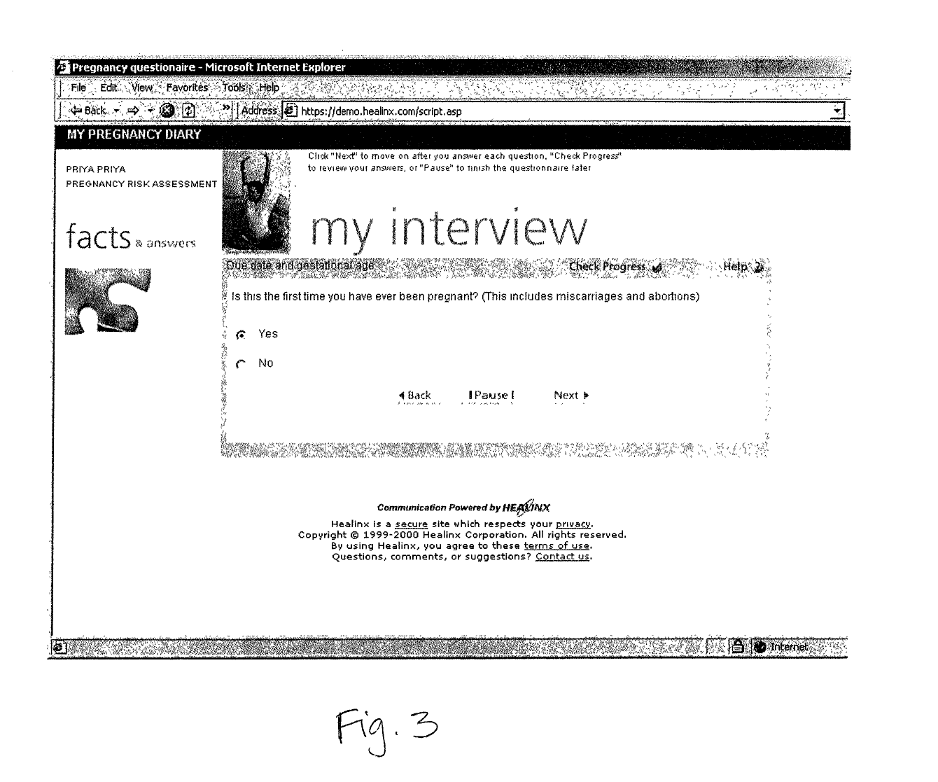

FIG. 3 shows a screen capture of the Web page that appears in the user's web browser when the user is in the middle of a survey. The HTML source code of the page is shown in Table 9. The current script path is encoded and returned with the HTML page.

[image]

[image]

[image]

[image]

[image]

[image]

[image]

[image]

[image]

[image]

[image]

[image]

[image]

[image]

[image]

[image]

[image]

TABLE 10
Non-encoded XML Structure for the Web Page of FIG. 3

<ROOT PVER=“1” KEY=“14” QKEY=“1419” SSNAME=“xsl/Test.xslt” HOBJ=“” NAME=“Sore Throat”
URL=“TestScript.asp” VER=“1” HELP=“Help/PTwebques.html” QPS=“5” IK=“33” PRXSLT=“xsl/Test.xslt”>

<SECTION KEY=“714” NAME=“Chief Complaint” ORDER=“1” DSTYLE=“1”/>
<SECTION KEY=“715” NAME=“History of Present Illness” ORDER=“2” DSTYLE=“1”/>
<SECTION KEY=“716” NAME=“Past Medical History” ORDER=“3” DSTYLE=“1”/>
<SECTION KEY=“717” NAME=“Additional Comments from Patient” ORDER=“4” DSTYLE=“1”/>
<STEP KEY=“1419” SKEY=“714” QTEXT=“To help me understand your current medical problem and

symptoms, please complete the following questionnaire.
&amp;It;p&amp;gt;
In a few words, please describe your condition and how I can help you today.” TYPE=“O” NRQKEY=“4834”
NRQNAME=“2” QNAME=“1” REQD=“1”>

<A KEY=“16972” DTYPE=“O” DATEC=“5”/>

</STEP>
<ANS/>
<STEP KEY=“4834” PRKEY=“1419” SKEY=“715” QTEXT=“How many days have you been having sore

throat symptoms?” TYPE=“1” NRQKEY=“5492” NRQNAME=“3” QNAME=“2” REQD=“1”>

<A KEY=“16973” LBL=“Less than 1 day” DTYPE=“0” DATEC=“5”/>
<A KEY=“16974” LBL=“1-2 days” DTYPE=“0” DATEC=“5”/>
<A KEY=“16975” LBL=“3-4 days” DTYPE=“0” DATEC=“5”/>
<A KEY=“16976” LBL=“More than 4 days” DTYPE=“0” DATEC=“5”/>

</STEP>
<STEP KEY=“5492” PRKEY=“4834” SKEY=“715” QTEXT=“On a scale of 1 to 10 with 10 being the

worst, please rank the severity of your sore throat symptoms.” TYPE=“1” NRQKEY=“5493” NRQNAME=“4”
QNAME=“3” REQD=“1”>

<A KEY=“19650” LBL=“1” DTYPE=“0” DATEC=“5”/>
<A KEY=“19651” LBL=“2” DTYPE=“0” DATEC=“5”/>
<A KEY=“19652” LBL=“3” DTYPE=“0” DATEC=“5”/>
<A KEY=“19653” LBL=“4” DTYPE=“0” DATEC=“5”/>
<A kEY=“19654” LBL=“5” DTYPE=“0” DATEC=“5”/>
<A KEY=“19655” LBL=“6” DTYPE=“0” DATEC=“5”/>
<A KEY=“19656” LBL=“7” DTYPE=“0” DATEC=“5”/>
<A KEY=“19657” LSL=“8” DTYPE=“0” DATEC=“5”/>
<A KEY=“19658” LBL=“9” DTYPE=“0” DATEC=“5”/>
<A KEY=“19659” LBL=“10” DTYPE=“0” DATEC=“5”/>

</STEP>
<STEP KEY=“5493” PRKEY=“5492” SKEY=“715” QTEXT=“Check all of the following symptoms that

you have.” TYPE=“3” NRQKEY=“5508” NRQNAME=“400” QNAME=“4” REQD=“1”>

<A KEY=“19660” LBL=“Swollen glands in neck” DTYPE=“0” DATEC=“5”/>
<A KEY=“19661” LBL=“Difficulty swallowing” DTYPE=“0” DATEC=“5”/>
<A KEY=“19662” LBL=“Congested or runny nose” DTYPE=“0” DATEC=“5”/>
<A KEY=“19663” LBL=“Sneezing” DTYPE=“0” DATEC=“5”/>
<A KEY=“19664” LBL=“Watery, itchy eyes” DTYPE=“0” DATEC=“5”/>
<A KEY=“19665” LBL=“Cough” DTYPE=“0” NKEY=“5496” NQNAME=“7” DATEC=“5”/>
<A KEY=“19666” LBL=“Fever” DTYPE=“0” NKEY=“5498” NQNAME=“12” DATEC=“5”/>
<A KEY=“19667” LBL=“Chills” DTYPE=“0” DATEC=“5”/>
<A KEY=“19668” LBL=“Headache” DTYPE=“0” DATEC=“5”/>
<A KEY=“19669” LBL=“Fatigue” DTYPE=“0” DATEC=“5”/>
<A KEY=“19670” LBL=“Muscle aches” DTYPE=“0” DATEC=“5”/>
<A KEY=“19671” LBL=“Nausea” DTYPE=“0” DATEC=“5”/>
<A KEY=“19672” LBL=“Vomiting” DTYPE=“0” NKEY=“5501” NQNAME=“15” DATEC=“5”/>
<A KEY=“19673” LBL=“Swollen, painful joints” DTYPE=“0” DATEC=“5”/>
<A KEY=“19674” LBL=“Gray, white, or yellow patches on throat or tonsils” DTYPE=“0” DATEC=“5”/>
<A KEY=“19675” LBL=“Drooling or difficulty controlling saliva” DTYPE=“0” DATEC=“5”/>
<A KEY=“19676” LBL=“Rash” DTYPE=“0” NKEY=“5504” NQNAME=“18” DATEC=“5”/>
<A KEY=“19677” LBL=“Painful teeth or painful gums” DTYPE=“0” DATEC=“5”/>
<A KEY=“19678” LBL=“Indigestion and/or heartburn” DTYPE=“0” DATEC=“5”/>
<A KEY=“19679” LBL=“Dark (cola) colored urine” DTYPE=“0” DATEC=“5”/>
<A KEY=“19680” LBL=“None of the above” DTYPE=“0” EOA=“1” DATEC=“5”/>

</STEP>

</ROOT>

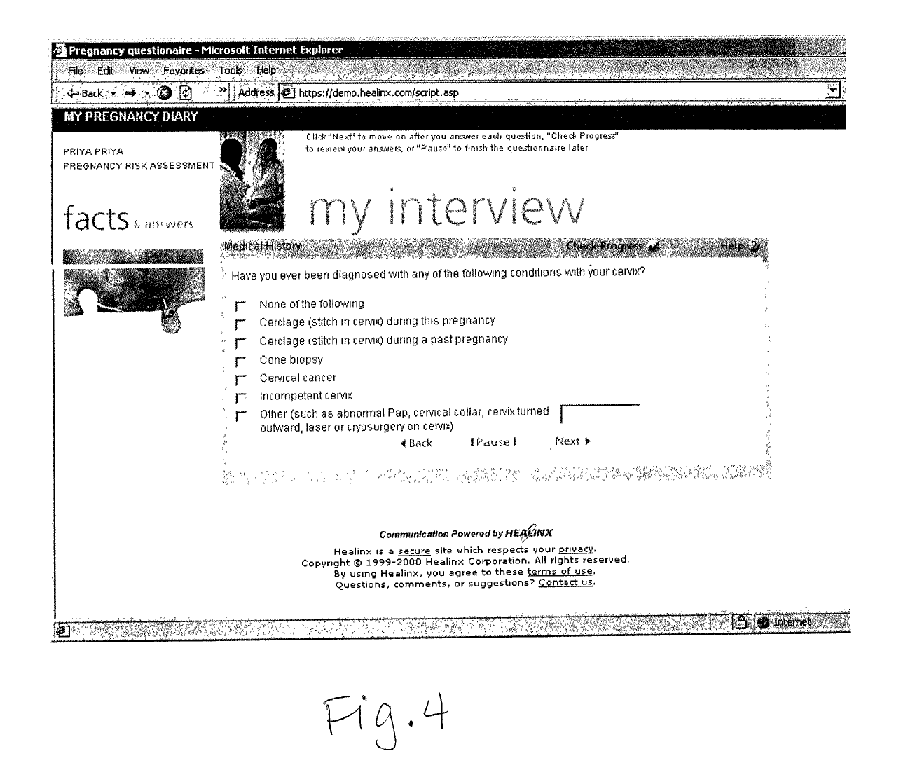

After the user supplies his answer to the question and clicks on “Next” button, the Web server 121 proceeds with Steps 201-212 and returning a page showing next question to the user's browser 111. The page is captured in FIG. 4, showing one question and multiple answers, one of which is a text answer.

The current script path (CSP) must be stored in a session of the Web server 121, because it is sent back and forth between the user's browser 111 and the Web server 121. The user may pause the survey session whenever he wants. The user can accomplish this by clicking on the “Pause” button as shown in FIG. 3 and FIG. 4. When the survey session is paused, the Web server 121 saves CSP to the database 123 just as in Step 221. When the user chooses to restore his unfinished survey session, the branch script object 124 reloads the user's CSP from the database 123 and the user is presented the same question that he was last presented immediately before the session was paused.

During a survey session, the user may go back to a previous question to correct his answer because the CSP contains all questions presented to him and all his responses. The user can accomplish this by clicking on the “Back” button as shown in FIG. 3 and FIG. 4.

In the process described above, the questions can be grouped into sections. The XSL templates may be modified to show which section a current question locates so that the user knows the progress of the survey. The progress of the survey is shown by the “Puzzle” to the left of the question in FIG. 3 and FIG. 4. Each section has its own picture. The XSL templates know how to show these pictures. When the user finishes the survey, he gets a complete puzzle.

Although the invention is described herein with reference to the preferred embodiment, one skilled in the art will readily appreciate that other applications may be substituted for those set forth herein without departing from the spirit and scope of the present invention.

Accordingly, the invention should only be limited by the claims included below.

What is claimed is:

1. A system for providing a question-answer branching session over a stateless network, said system comprising:
a Web server;
a web content medium coupled to said Web server;
a database coupled to said Web content;
a branch script object coupled to said Web content, and a plurality of Web clients;
wherein said Web server and said Web clients communicate over the Internet.

2. The systems of claim 1, wherein said database comprises:
a first table for storing information about how a script path is constructed and what features said script supports;
a second table for storing information about questions;
a third table for storing information about answers;
a fourth table for storing information about sections; and
a fifth table for saving a current script path when said script path is paused or completed.

3. The system of claim 2, wherein said first table comprises:
a first column for an identity of said first table;
a second column for a server timestamp value for concurrency;
a third column for a name of an object that handles special custom treatment for said script;
a fourth column for a name of said script;
a fifth column for a first XSL file that is used to transform the current script path into an HTML page;
a sixth column for a bit value to indicate that said script has sections;
a seventh column for a flag to indicate that said script can be paused;
an eighth column for a flag to indicate that said script displays a progress button;
a ninth column for a page that handles submissions of said script when it is executed;
a tenth column for an image file that is used while said script is being executed; and
an eleventh column for a name of a second XSL file that is used to display the progress.

4. The system of claim 2, wherein said second table comprises:
a first column for an identity of said second table;
a second column for a server timestamp value for concurrency;
a third column for a foreign key to said fourth table that indicates the section to which a question belongs;
a fourth column for a flag that indicates that a question text and a generated text need to be parsed for token names and replaced with token values;
a fifth column for a text that needs to be displayed while said question is being displayed;
a sixth column for a display text that is used when an end result is generated from execution of said script;
a seventh column for an answer type that is expected for said question;
an eighth column for a flag to indicate that said question is a required question;
a ninth column for a text that is used for displaying any help information on said question;
a tenth column for a foreign key to indicate a default question when no answer is given for said question;
an eleventh column for a name of said question used internally within said script; and
a twelfth column for a foreign key to said question to be displayed as a next question at the end of branch.

5. The system of claim 2, wherein said third table comprises:
a first column for an identity of said third table;
a second column for a server timestamp value for concurrency;
a third column for a name of a label which is displayed when said answer is displayed;
a fourth column for a foreign key to a question to which said answer belongs;
a fifth column for a display text that is used when said answer is chosen;
a sixth column for a text that is to be added as a prefix to said display text;
a seventh column for a text that is to be added as a suffix to said display text;
an eighth column for a name of a token that said answer generates;
a ninth column for a foreign key to a next question that is to be displayed when said answer is provided;
a tenth column for a flag to indicate that said answer that is displayed is to be an answer that is entered on an HTML page; and
an eleventh column for a flag to indicate that a text box next to said answer needs to be displayed.

6. The system of claim 2, wherein said fourth table comprises:
a first column for an identity of said fourth table;
a second column for a server timestamp value for concurrency;
a third column for a foreign key of said script to which a section belongs;
a fourth column for a name of said section;
a fifth column for an order of said section; and
a six column for a name of an image file that is to be used when a question to which said section belongs is being displayed.

7. The system of claim 1, wherein said branch script object processes an XML structure, wherein said XML structure comprises a script as a root element, and wherein said root element comprises:
a first attribute that defines a first key in said database for said script;
a second attribute that defines a second key in said database for said script when it is saved;
a third attribute defines a key of a first question that is displayed when said script is executed;
a fourth attribute defines a name of said first question that is displayed when said script is executed;
a fifth attribute that defines a name of an XSL file that is used to display the content of said script;
a sixth attribute that defines a name of a server that deals with any special handling for said script;
a seventh attribute that defines a name of said branch script object;
an eighth attribute that defines the URL of an image that needs to be displayed while said script is being executed;
a ninth attribute that defines the URL to which a form is submitted;
a tenth attribute that defines a flag that indicates that said script can be paused;
an eleventh attribute that defines a flag that indicates that said script is set to show progress button;
a twelfth attribute that defines a flag that indicates that the end of said script is reached;
a thirteenth attribute that defines a flag that indicates that the beginning of said script is reached by moving previous on said script;
a first node that indicates a place holder for section details for different sections in said script;
a second node that indicates a place holder for holding different tokens elements in XML;
a third node that indicates a third holder for each answer that is placed on a stack;
a fourth node that indicates a place holder for each question that has been answered; and
a fifth node that indicates a place holder for a current question that is to be displayed.

8. The system of claim 7, wherein said first node comprises:
a first attribute that defines a key of said section;
a second attribute that defines a name as it exists in said database for said section;
a third attribute that defines an order as it exists in said database for said section; and
a fourth attribute that defines an image value for said section as it exists in said database.

9. The system of claim 7, wherein said second node comprises:
a plurality of child nodes, wherein each said child node indicates a place holder for each token value under said second node.

10. The system of claim 9, wherein said child node comprises:
a first attribute that defines a key of a question that has generated a token;
a second attribute that defines a key of an answer to said question that has generated said token;
a third attribute that defines a name of said token; and
a fourth attribute that defines a value that is entered in an answer field for said question.

11. The system of claim 7, wherein said third node comprises:
a plurality of child nodes, wherein each said child node indicates a place holder for each answer that is placed into said stack.

12. The system of claim 11, wherein said child node comprises:
a first attribute that defines a key of said current question;
a second attribute that defines a key of a next question that is to be displayed for said answer; and
a third attribute that defines a name of said next question that is to be displayed for said answer.

13. The system of claim 7, wherein said fourth node comprises:
a plurality of child notes, wherein each said child node indicates a place holder for each answer that is received from a user for said question;
a first attribute that defines a key of said question that the user has answered;
a second attribute that defines a name of said question as it exists in said database;
a third attribute that defines a text that is to be displayed when said question is being displayed in a progress report;
a fourth attribute that defines a key of a previous question that the user answered before answering said question;
a fifth attribute that defines a flag that indicates that said question was displayed as a result of an answer being popped from said stack; and
a sixth attribute that defines a key of a question that has generated an entry for said question in said stack.

14. The system of claim 13, wherein said child node comprises:
a first attribute that defines a key of a response made by the user; and
a second attribute that defines a value that is to be displayed when the progress for said script is displayed.

15. The system of claim 7, wherein said fifth node comprises:
a plurality of child nodes, wherein each said child node indicates a place holder for each answer that is received from the user for said question;
a first attribute that defines a key of said current question that the user needs to answer;
a second attribute that defines a name of said current question as it exists in said database;
a third attribute that defines a key of a previous question that the user answered prior to answering said current question;
a fourth attribute that defines a key of a section to which said current question belongs;
a fifth attribute that defines a question text that is displayed when the user is prompted with said current question;
a sixth attribute that defines a text that is displayed when the progress is displayed to the user;
a seventh attribute that defines an answer type for said current question;
an eighth attribute that defines a help text for said current question;
a ninth attribute that defines a flag that indicates that said current question is a required question in said database;
a tenth attribute that defines a flag that indicates that said current question was displayed as a result of an answer that is being popped from said stack;
an eleventh attribute that defines a key of a question that has generated an entry for said current question in said stack;
a twelfth attribute that defines a key of a question that is to be a default next question when no answer is provided;
a thirteenth attribute that defines a next root at which the questioning continues once the end of branch is reached; and
a fourteenth attribute for displaying errors.

16. The system of claim 15, wherein said child node comprises:
a first attribute that defines a key of an answer to said current question, wherein said key is stored in said database;
a second attribute that defines a label that is to be displayed for said current answer;
a third attribute that defines a display value for said current answer that is to be displayed;
a fourth attribute that defines a prefix that is to be added to the user response;
a fifth attribute that defines a suffix that is to be appended to the user response;
a sixth attribute that defines a name of a token that is to be generated when the user enters a value as a response;
a seventh attribute that defines a key of a next question that is to be displayed when the user enters a value as a response;
an eighth attribute that defines a flag for displaying said answer as is; and
a ninth attribute that defines a flag for showing a text box for said answer

17. The system of claim 1, wherein said branch script object comprises:
a first property which is used when said branch script object queries said database;
a second property which is a value of said server that is responsible for special handling, if any;
a third property which is an object that is created using said second property;
a fourth property which is a key of said script that is to be executed;
a fifth property which is a document object model that holds said XML;
a sixth property which is a name of a first XSL file that is used to transform XML into HTML;
a seventh property which is a name of a second XSL file that is used to display the progress;
an eighth property which is a name of an image file that is used to display a logo for said script;
a ninth property which is the URL of a page that processes the submission of a script form;
a tenth property which is a key of a question that exists as said fifth node in XML;
an eleventh property which is a key of a previous question that was displayed before said current question;
a twelfth property which returns true if the end of script is reached;
a thirteenth property which returns true if the beginning of script is reached;
a fourteenth property which becomes said fourteenth attribute of said fifth node; and
a fifteenth property which is a login key of the user who attempts to save the progress or resume a paused script.

18. The system of claim 1, wherein said branch script object comprises:
a first method, which is called first for executing said script;
a second method, which is called for setting a stage to display a starting question;
a third method, which is called to rebuild said XML structure using a variable in a form collection of a request object;
a fourth method, which is called to convert said fifth node to an equivalent fourth node using XML;
a fifth method, which is called to take a previous question from said fifth node using XML;
a sixth method, which is called to display said current question;
a seventh method, which is called to display the progress;
an eighth method, which is called when the end of script is reached;
a ninth method, which is called when said script is paused;
a tenth method, which is called when said paused script is to be resumed; and
an eleventh method, which is called for setting a stage to display said paused script from the very point where a session was interrupted.

19. The system of claim 18, wherein, if a script key is passed in, said first method copies said script key into a member variable;
wherein if said script key is not passed in, said method assumes that a value is set using a property procedure; and
wherein said method queries said database for details of said script and creates a base XML structure.

20. The system of claim 18, wherein said second method goes to said database using a starting question key for said script and then creates said fifth node using all values that it retrieved.

21. The system of claim 18, wherein said third method checks if said question is a required question and returns a false if no answer to said required question is provided.

22. The system of claim 18, wherein said fourth method creates a child node under said fourth node using said request object;
wherein before the creation of said child node of said fourth node, said request object checks to make sure that a valid answer exists; and
wherein if no valid answer exists, said object uses a key that is defined by said twelfth attribute of said fifth node to determine a next question.

23. The system of claim 18, wherein if a previous question is not found, said fifth method takes steps of:
getting rid of said fifth node;
setting said thirteenth attribute of said root element; and
returning an indicator; and
wherein if a previous question is found, said fifth method takes steps of:
when said tenth attribute of said fifth node are set,
reinstating said stack for said question using said eleventh attribute of said fifth node;
getting rid of said fifth node;
locating said fourth node;
getting rid of all child nodes under said second node and said third node that were created as a result of said answers to said fourth node;
querying said database using a previous question key;
creating said fifth node; and
copying said previous question key value from said fourth node into said fifth node; and
when said fifth attribute and sixth attribute of said fourth node are set,
copying said fifth attribute and sixth attribute of said fourth node into said fifth node;
getting rid of said fourth node; and
returning said previous question.

24. The system of claim 18, wherein said sixth method, using XML, checks whether said fifth node exists;
wherein if said fifth node exists, said sixth method takes the steps of:
transforming XML using said sixth property;
adding form tags to said transformed XML;
calling a form script;
setting an action to said ninth property value;
hiding said XML in an input item; and
returning HTML.

25. The system of claim 18, wherein said seventh method takes the steps of:
transforming XML using said seventh property;
adding form tags to said transformed XML;
calling a form script;
setting an action to said ninth property value;
hiding said XML in an input item; and
returning HTML.

26. The system of claim 18, wherein said eighth method takes the steps of:
setting said fifteenth property value;
checking if a saved key value exists in said XML;
performing an update using said saved key value if said saved key value is found;
inserting said XML in said fifth table if said saved key value is not found; and
setting a completion.

27. The system of claim 18, wherein said ninth method takes the steps of:
setting said fifteenth property value;
checking if a saved key value exists in said XML;
performing an update using said saved key value if said saved key value is found;
inserting said XML in said fifth table if said saved key value is not found; and
setting a completion.

28. The system of claim 18, wherein said tenth method first authenticates the user and then rebuilds said XML structure by reading said database.

29. The system of claim 18, wherein said eleventh method ensures that said
fifth node exists so that the user can proceed with resuming said paused script.

30. The system of claim 1, wherein said branch script object can be customized by
implementing a method that is called for handling special issues, if any, the first thing when said second method is executed.

31. The system of claim 1, wherein said branch script object can be customized by implementing a method that is called for handling special issues, if any, just before the execution of said second method is completed.

32. The system of claim 1, wherein said branch script object can be customized by implementing a method that is called for handling special issues, if any, the first thing when said fourth method is executed.

33. The system of claim 1, wherein said branch script object can be customized by implementing a method that is called for handling special issues, if any, just before the execution of said fourth method is completed.

34. The system of claim 1, wherein said branch script object can be customized by implementing a method that is called for handling special issues, if any, the first thing when said fifth method is executed.

35. The system of claim 1, wherein said branch script object can be customized by implementing a method that is called for handling special issues, if any, just before the execution of said fifth method is completed.

36. The system of claim 1, wherein said branch script object can be customized by implementing a method that is called for handling special issues, if any, the first thing when said eleventh method is executed.

37. The system of claim 1, wherein said branch script object can be customized by implementing a method that is called for handling special issues, if any, just before the execution of said eleventh method is completed.

38. The system of claim 1, wherein said branch script object can be customized by implementing a method that is called for handling special issues, if any, the first thing when said ninth method is executed.

39. The system of claim 1, wherein said branch script object can be customized by implementing a method that is called for handling special issues, if any, the first thing when said eighth method is executed.

40. The system of claim 1, wherein said branch script object can be customized by implementing a method that is called for handling special issues, if any, the first thing when said sixth method is executed.

41. The system of claim 1, wherein said branch script object can be customized by implementing a method that is called for handling special issues, if any, the first thing when said seventh method is executed.

42. A process for providing a question-answer branching session over a stateless network, said process comprising the steps of:
submitting, by a user, a first answer to a question;
receiving, by a Web server, said first answer;
encoding, by said Web server, a current script path;
calling, by said Web server, said branch script object;
if this is the start of a script path, then
querying, by said branch script object, said database for details of said script;
creating, by said branch object, an XML structure; and
creating, by said branch object, said fifth node using a starting question for said script;
if this is not the start of said script path, then
decoding, by said Web server, said encoded current script path;
rebuilding, by said Web server, said XML structure; and
checking whether an answer is provided;
wherein said answer may be a single answer, a text answer, or a multiple answer.

43. The process of claim 42 and further comprising the steps of:
if said first answer is a text answer, then
adding, by said branch script object, said text answer as a named token to said current script path, wherein said text answer is configured to be a token so that said token can be used in subsequent questions and answers;
if said first answer is a multiple answer, then
finding, by said branch script object, a next question by using said first answer; and
keeping the remaining answers to said stack of said branch script object,
wherein said script path for the remaining answers may be branched when said current script path for a current answer is completed.

44. The process of claim 43 and further comprising the steps of:
adding, by said branch script object, said first answer to the current script path along with said current question; and
querying, by said branch script object, said database for said next question based on said current question and said answer to said current question on said script path;
wherein if there are further questions, said process goes on a first sub-process, and
wherein if there are no further questions, said process goes on a second sub-process.

45. The process of claim 44, wherein said first sub-process comprises the steps of:
adding, by said branch script object, said next question to said current script path, wherein said next question becomes a current question;
formatting, by said branch script object, said question to an HTML page;
sending, by said branch script object, said question to the user's browser along with said current script path;
encoding, by said branch script object, said current script path; and
including said current script path into a responding HTML page;
wherein said current script path contains said questions presented to the user including said current question, the user's answers to said questions, said remaining answers to be branched, and said tokens that have been collected; and
wherein said responding HTML page contains questions, answers, help text, generated text, and navigational elements.

46. The process of claim 44, wherein said second sub-process comprises the steps of:
saving, by said branch script object, said current script path to said database;
if said current script path has been already saved to said database for a pause request, then
updating said saved current script path;
if said current script path has not been saved yet, then
inserting, by said branch script path, said current script path into said fifth table of said database;
wherein said questions and answers that are contained in said current script path may be retrieved for further processing; and
formatting, by said branch script object, an HTML page that notifies the user the completion of said session.

47. A method for providing a question-answer branching session over a stateless network, said method comprising the steps of:
submitting, by a user, a first answer to a question;
receiving, by a Web server, said first answer;
encoding, by said Web server, a current script path;
calling, by said Web server, said branch script object;
if this is the start of a script path, then
querying, by said branch script object, said database for details of said script;
creating, by said branch object, an XML structure; and
creating, by said branch object, said fifth node using a starting question for said current script;
if this is not the start of said script path, then
decoding, by said Web server, said encoded current script path;
rebuilding, by said Web server, said XML structure; and
checking whether an answer is provided;
wherein said answer may be a single answer, a text answer, or a multiple answer.

48. The method of claim 47 and further comprising the steps of:
if said first answer is a text answer, then
adding, by said branch script object, said text answer as a named token to said current script path, wherein said text answer is configured to be a token so that said token can be used in subsequent questions and answers;
if said first answer is a multiple answer, then
finding, by said branch script object, a next question by using said first answer; and
keeping the remaining answers to said stack of said branch script object,
wherein said script path for the remaining answers may be branched when said current script path for said current answer is completed.

49. The method of claim 48 and further comprising the steps of:
adding, by said branch script object, said first answer to said current script path along with said current question; and
querying, by said branch script object, said database for said next question based on said current question and said answer to said current question on said script path;
wherein if there are further questions, then a step of next question is followed, and
wherein if there are no further questions, then a step of completion is followed.

50. The method of claim 49, wherein said step of next question comprises the sub-steps of:
adding, by said branch script object, said next question to said current script path, wherein said next question becomes a current question;
formatting, by said branch script object, said question to an HTML page;
sending, by said branch script object, said question to the user's browser along with said current script path;
encoding, by said branch script object, said current script path; and
including said current script path into a responding HTML page;
wherein said current script path contains said questions presented to the user including said current question, the user's answers to said questions, said remaining answers to be branched, and said tokens that have been collected; and
wherein said responding HTML page contains questions, answers, help text, generated text, and navigational elements.

51. The method of claim 50, wherein said step of completion comprises the sub-steps of:
saving, by said branch script object, said current script path to said database;
if said current script path has been already saved to said database for a pause request, then
updating said saved current script path;
if said current script path has not been saved yet, then
inserting, by said branch script path, said current script path into said fifth table of said database;
wherein said questions and answers that are contained in said current script path may be retrieved for further processing; and
formatting, by said branch script object, an HTML page that notifies the user the completion of said session.
